(19) United States
(12) Patent Application Publication
(10) Pub. No.: US 2025/0030491 A1
(43) Pub. Date: Jan. 23, 2025

(54) METHOD AND APPARATUS FOR RADIO FREQUENCY INTERFERENCE PATTERN IDENTIFICATION

(71) Applicant: Dell Products, LP, Round Rock, TX (US)

(72) Inventor: Jui Chang Liu, New Taipei City (TW)

(73) Assignee: Dell Products, LP, Round Rock, TX (US)

(21) Appl. No.: 18/223,385

(22) Filed: Jul. 18, 2023

(51) Int. Cl. H04B 17/318; G06F 13/38; H04B 17/345

(52) U.S. Cl. CPC H04B 17/318; G06F 13/382; H04B 17/345; G06F 2213/0042

(57) ABSTRACT

An information handling system may include a hardware processor, a memory device, wireless systems, a power source, and plural Universal Serial Ports (USB) or the information handling system may be operatively coupled to a docking station with the plural USB ports. The information handling system may utilize a wireless dongle operatively coupled to the hardware processing device via one USB port that is wirelessly coupled to a wireless input/output device, the wireless dongle comprising a wireless dongle antenna to send and receive data wirelessly with the wireless device, a wireless dongle hardware processing device, and wireless dongle wireless interference detection firmware to detect fail parameters. Execution of code instructions of a wireless interference determination system by the hardware processor may determine combinations of fail parameters diagnose wireless interference from another USB port or other wireless devices as well as determine other wireless signal issues and generate remediation instructions.

### FIELD OF THE DISCLOSURE

The present disclosure generally relates to radio frequency interference patterns identifications. The present disclosure more specifically relates to radio frequency interference patterns identifications at a wireless dongle or other wireless device.

### BACKGROUND

As the value and use of information continues to increase, individuals and businesses seek additional ways to process and store information. One option available to clients is information handling systems. An information handling system generally processes, compiles, stores, and/or communicates information or data for business, personal, or other purposes thereby allowing clients to take advantage of the value of the information. Because technology and information handling needs and requirements vary between different clients or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific client or specific use, such as e-commerce, financial transaction processing, airline reservations, enterprise data storage, or global communications. In addition, information handling systems may include a variety of hardware and software components that may be configured to process, store, and communicate information and may include one or more computer systems, data storage systems, and networking systems. Furthermore, information handling systems may include hardware that includes a wireless dongle or other wireless device used to operatively and wirelessly couple a wireless device to the information handling system.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of an information handling system including a wireless device such as a wireless dongle used to operatively couple a wireless device to the information handling system according to an embodiment of the present disclosure;

FIG. 2 is a graphic diagram of an information handling system including a wireless device or a wireless dongle used to operatively couple a wireless device to the information handling system according to an embodiment of the present disclosure;

FIG. 3 is a process flow diagram showing a process of gathering data on wireless interference and on a wireless data transmitting signal to and from a wireless dongle operatively coupled to an information handling system via a universal serial bus (USB) port according to an embodiment of the present disclosure;

FIG. 4 is a block diagram of an arrangement of a wireless dongle or other wireless device and information handling system relative to a plurality of wireless devices wirelessly coupled to the information handling system via a docking station according to another embodiment of the present disclosure;

FIG. 5 is a flowchart diagram of a method of detecting and troubleshooting wireless interference at a wireless dongle operatively coupled to an information handling system via a universal serial bus (USB) port comprising according to an embodiment of the present disclosure; and

FIG. 6 is a flowchart diagram of a method of generating instructions for executing remedial actions upon a determination of a type of wireless interference that has been detected at a wireless device or wireless dongle according to an embodiment of the present disclosure.

The use of the same reference symbols in different drawings may indicate similar or identical items.

### DETAILED DESCRIPTION OF THE DRAWINGS

The following description in combination with the figures is provided to assist in understanding the teachings disclosed herein. The description is focused on specific implementations and embodiments of the teachings and is provided to assist in describing the teachings. This focus should not be interpreted as a limitation on the scope or applicability of the teachings.

Information handling systems operate to provide computing, data storage, and application resources among other computing resources. Among these other resources includes wireless coupling of a wireless device to the information handling system. In addition to the information handling system including an internal radio that allows for Wi-Fi and/or Bluetooth® (BT) connection to other wireless devices, a wireless dongle may also be used to operatively couple a wireless device to the information handling system. The wireless dongle may be inserted into a universal serial bus (USB) port formed within the housing of the information handling system or into a docking station operatively coupled to the information handling system via a lightning or USB (e.g., USB-A, -B, or -C) port. Multiple USB ports may be nearby to the USB port supporting a wireless dongle or a wireless adapter of an information handling system or docking station. Other USB devices may be also inserted into these other ports at a docking station or an information handling system, but with insufficient shielding may generate radio interference at the USB port contact or connection.

Since, the wireless dongle may operatively couple the information handling system to a wireless device, interference may come from such additional USB ports or USB devices having insufficient shielding or may come from other wireless input/output (IO) devices operating in a nearby area in some embodiments. Additional wireless problems may also arise that impact wireless communications at a wireless dongle or wireless adapter with wireless IO devices. In an embodiment, example wireless devices may include a wireless mouse, a wireless keyboard, a wireless headset, among other peripheral wireless devices, and base stations and access points among other wireless devices. Example USB devices may further include USB memory or storage devices, USB connections to external displays, or other USB IO devices or other devices. These wireless devices communicate with the information handling at the 2.4 GHz frequency band or other frequency bands. This frequency band includes a limited number of non-overlapping channels and congestion amongst these channels can cause interference where multiple wireless devices are operatively communicating with the information handling system or other information handling systems nearby on adjacent or nearby channels. Further, outside sources may cause wideband interference, such as unshielded or insufficiently shielded USB connectors near the wireless dongle or wireless device. This wideband interference may similarly cause interference and degradation of wireless communications at the wireless dongle or the wireless device. Thus, where a wireless dongle is operating at a 2.4 GHz band or other wireless band at a first USB port in an information handling system or docking station operatively coupled with the information handling system, a second neighboring device is operating at a neighboring USB port, even when it is not transmitting wirelessly, may cause interference due to data transfer across the connector, especially if the connector is insufficiently shielded. An information handling system or wireless dongle manufacturer cannot necessarily predict or control the sufficiency of wireless shielding for devices attached to USB ports at the information handling system or a docking station that are nearby to a wireless dongle, a wireless adapter, or a wireless device. Other USB ports may be used to attach any other types of IO devices, display devices, memory devices, or the like to an information handling system or a docking station. This can cause wireless performance problems at the wireless dongle, wireless adapter, or wireless device.

The present specification, therefore, describes a software or hardware based wireless dongle interference detection system executing code instructions at an information handling system or wireless dongle to detect interference and determine a type of interference in embodiments herein. Further the code instructions executed of the wireless interference determination system on the information handling system may take the determination of a type of interference and generate a recommendation output to a user to mitigate or remediate the interference or wireless performance degradation detected. The information handling system includes a hardware processing device, a memory device, and a power management unit (PMU) to provide power to the hardware processing device and the memory device. A wireless dongle is operatively coupled with the information handling system at a USB port (a first USB port among a plurality of USB ports). The wireless dongle, in addition to being operatively coupled to the hardware processing device via a USB port of the information handling system, is also wirelessly coupled to a wireless device. In an embodiment, the wireless dongle comprises a wireless dongle antenna to send and receive data wirelessly with the wireless device, a wireless dongle hardware processing device, and wireless dongle wireless interference detection firmware comprising a wireless interference detection algorithm to, when executed by the wireless dongle hardware processing device, detects fail parameters. These fail parameters may include a received signal strength indicator (RSSI) of interference levels at the wireless dongle antenna (e.g., a RSSI of interference) that is above a first interference threshold RSSI value, as well as an RSSI level of received packet signal data (e.g., a received data packet RSSI value) that is below a second packet data threshold RSSI value, and a number of resend data packets exceeding a threshold resend data packet value within a period of time any of which may be detected concurrently at the wireless dongle hardware processing device. In an embodiment, upon detection of a fail parameter, the wireless dongle hardware processing device may provide an alert to the hardware processing device to execute computer readable program code of a wireless interference determination system to determine a type of wireless device signal interference at the wireless dongle antenna resulting from the detected fail parameter and generate instructions to perform a remedial action to the component systems or wireless dongle to correct the wireless device signal interference identified.

In an embodiment, the hardware processing device executes the computer readable program code of the wireless interference determination system to generate instructions to perform a remedial action on one or more hardware components or software systems of the information handling system, its wireless dongle, or operatively coupled wireless devices in various embodiments. In one embodiment, the hardware processing device executes the computer readable program code of the wireless interference determination system to generate instructions to perform a remedial action including generating and presenting a GUI notification via a graphical user interface to a user of the information handling system on a display device to move the wireless dongle or another USB device away from one another due to USB connector generated interference. In another embodiment, the hardware processing device executes the computer readable program code of the wireless interference determination system to generate instructions or commands to a USB driver software or device to disable, limit, or alternate operation of one or more USB ports for the dongle or the nearby operatively coupled USB device causing interference. In yet another embodiment, the hardware processing device executes the computer readable program code of the wireless interference determination system to generate instructions for a GUI notification to be presented to a user via a graphical user interface on a display device to perform a remedial action including a generated GUI notification to a user of the information handling system to move the information handling system from competing wireless equipment or move the competing wireless IO device. In another embodiment, the hardware processing device executes the computer readable program code of the wireless interference determination system to generate instructions or commands to a wireless dongle radio to adjust operation of the wireless dongle radio to shift an operating channel in the BT® wireless communication band to avoid a competing wireless IO device nearby operating with a different information handling system. In still another embodiment, the hardware processing device executes the computer readable program code of the wireless interference determination system to send instructions to the wireless device to increase wireless transmission power used to communicate with the wireless dongle, wireless adapter, or wireless device.

In an embodiment, a docking station is operatively coupled to the information handling system with the docking station including a plurality of USB ports. In an embodiment, the wireless dongle is operatively coupled into a first of the plurality of USB ports with other USB devices being operatively coupled to one of the other plurality of USB ports for use by the other USB devices. Consequently, the present specification contemplates that the systems and methods may operate when the wireless dongle is inserted into a USB port formed in the housing of the information handling system or into the housing of a docking station operatively coupled with the information handling system.

For additional monitoring purposes, the information handling system may operatively be coupled to a backend server to provide telemetry data to the backend server for information handling system management services. The telemetry data and the information handling system management services may be used in the future to determine how users are operating the information handling system with the wireless dongle as well as update, if necessary, the wireless interference detection algorithm to better detect and remediate wireless interference at the users' information handling systems.

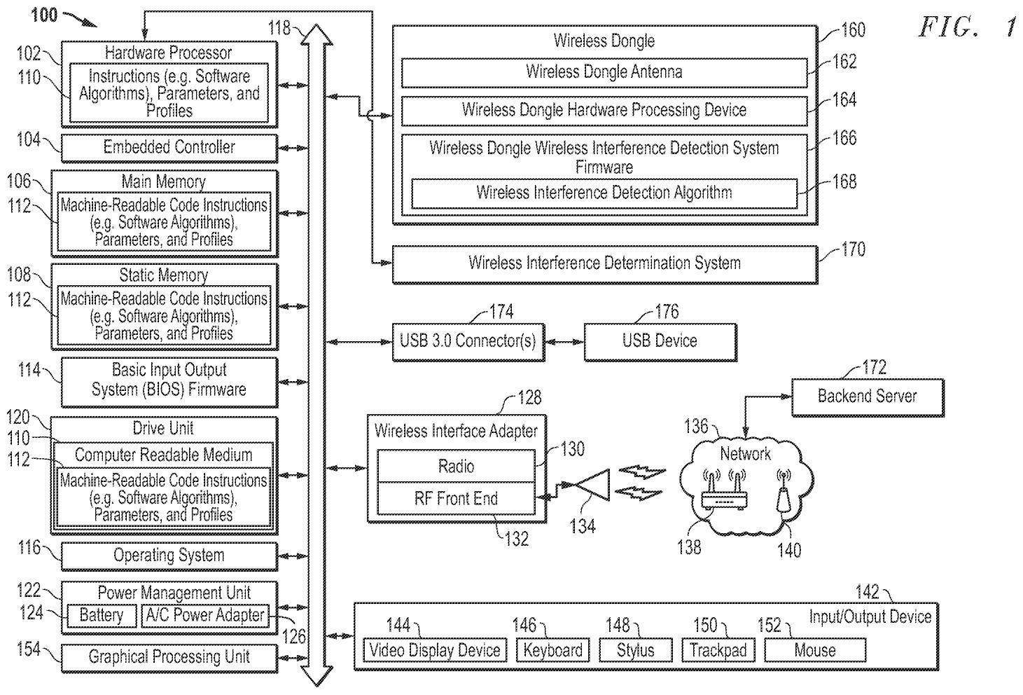

FIG. 1 illustrates an information handling system 100 similar to information handling systems according to several aspects of the present disclosure. In the embodiments described herein, an information handling system 100 includes any instrumentality or aggregate of instrumentalities operable to compute, classify, process, transmit, receive, retrieve, originate, switch, store, display, manifest, detect, record, reproduce, handle, or use any form of information, intelligence, or data for business, scientific, control, entertainment, or other purposes. For example, an information handling system 100 can be a personal computer, mobile device (e.g., personal digital assistant (PDA) or smart phone), server (e.g., blade server or rack server), a consumer electronic device, a network server or storage device, a network router, switch, or bridge, wireless router, or other network communication device, a network connected device (cellular telephone, tablet device, etc.), IoT computing device, wearable computing device, a set-top box (STB), a mobile information handling system, a palmtop computer, a laptop computer, a desktop computer, a convertible laptop, a tablet, a smartphone, a communications device, an access point (AP), a base station transceiver, a wireless telephone, a control system, a camera, a scanner, a printer, a personal trusted device, a web appliance, or any other suitable machine capable of executing a set of instructions (sequential or otherwise) that specify actions to be taken by that machine, and can vary in size, shape, performance, price, and functionality. In and embodiment, the information handling system 100 includes a wireless dongle 160. The wireless dongle 160 may be operatively coupled, in an embodiment, with the information handling system 100 via a universal serial bus (USB) port 174 formed in the housing of the information handling system 100 and operatively coupled to a hardware processor 102 of the information handling system 100 in an embodiment. In another embodiment, the wireless dongle 160 may be operatively coupled to the hardware processor 102 of the information handling system 100 via a docking station (not shown) and connecting cable with the docking station also including a USB port for the wireless dongle 160 to be inserted into. For purposes of the present specification, the term “wireless dongle” is meant to be understood as a hardware component that is connected to a USB port (e.g., USB 3.0 174) that, in the context of the present specification, wirelessly communicates with a wireless device such as a wireless mouse 152, a wireless keyboard 146, a wireless headset (not shown), among other peripheral wireless devices 142, and base stations 140 and access points 138 among other wireless devices. As such, in an embodiment, the wireless dongle 160 includes a wireless dongle antenna 162 used to provide wireless communication with these devices. Although the present specification describes a wireless dongle that is used to communicate with a wireless device, the present specification also contemplates that a wireless system (e.g., a wireless interface adapter 128, radio 130, RF front end 132) may also be used in connection with the execution of the wireless dongle wireless interference detection system firmware 166 and the wireless interference detection algorithm 168 as described herein. USB port 174 may include plural USB ports in the housing of information handling system 100 or in a docking station and may accept not only a wireless dongle but other USB device according to embodiments herein. USB ports 174 may be managed or operated with a USB driver software executing via a hardware resources such as hardware processor 102 or embedded controller 104 in some embodiments. The USB driver software may control operation and availability of the one or more USB ports 174 in some embodiments. Such USB ports 174 may be nearby one another and may have issues of insufficient shielding and generation of interference according to some embodiments herein.

In a networked deployment, the information handling system 100 may operate in the capacity of a server or as a client computer in a server-client network environment, or as a peer computer system in a peer-to-peer (or distributed) network environment. In a particular embodiment, the computer system 100 can be implemented using electronic devices that provide voice, video, or data communication. For example, an information handling system 100 may be any mobile or other computing device capable of executing a set of instructions (sequential or otherwise) that specify actions to be taken by that machine. In an embodiment, the information handling system 100 may be operatively coupled to a server (e.g., backend server) or other network device. Further, while a single information handling system 100 is illustrated, the term “system” shall also be taken to include any collection of systems or sub-systems that individually or jointly execute a set, or multiple sets, of instructions to perform one or more computer functions.

The information handling system 100 may include memory (volatile (e.g., random-access memory, etc.), nonvolatile (read-only memory, flash memory etc.) or any combination thereof), one or more hardware processing resources, such as a central processing unit (CPU), a graphics processing unit (GPU) 154, an embedded controller (EC) 104, a hardware processor 102, hardware controllers, or any combination thereof. In an embodiment, the hardware processor 102 may include a central processing unit (CPU) that participates in executing computer program code of a wireless interference determination system 170 described herein. Additional components of the information handling system 100 can include one or more storage devices, one or more communications ports for communicating with external devices, as well as various input and output (I/O) devices 142, such as a keyboard 146, a mouse 152, a video display device 144, a stylus 148, a trackpad 150, or any combination thereof. In an embodiment, these I/O devices 142 may be wired or wireless and may operatively couple via a wireless dongle 160 or directly as a USB device 176 via USB connector 174 that may be physically near a USB port with a wireless dongle 160. The information handling system 100 can also include one or more buses 118 operable to transmit data communications between the various hardware components described herein. Portions of an information handling system 100 may themselves be considered information handling systems and some or all of which may be wireless.

Information handling system 100 can include devices or modules that embody one or more of the devices or execute instructions for the one or more systems and modules described above and operates to perform one or more of the methods described herein. The information handling system 100 may execute machine-readable code instructions 112 via the described hardware processing resources that may operate on servers or systems, remote data centers, or on-box in individual client information handling systems according to various embodiments herein. In some embodiments, it is understood any or all portions of machine-readable code instructions 112 may operate on a plurality of information handling systems 100.

As described herein, the information handling system 100 may include hardware processing resources such as a hardware processor 102, a central processing unit (CPU), accelerated processing unit (APU), an embedded controller (EC) 104, a neural processing unit (NPU), a vision processing unit (VPU), a digital signal processor (DSP), a GPU 154, a microcontroller, or any other type of hardware processing device that executes code instructions to perform the processes described herein. Any of the hardware processing resources may operate to execute code that is either firmware or software code. Moreover, the information handling system 100 can include memory devices such as main memory 106, static memory 108, computer readable medium 110 storing instructions 112 (e.g., embodied as firmware in some embodiments) of, in an example embodiment, wireless interference determination system 170 or other computer executable program code and firmware, and drive unit 120 (volatile (e.g., random-access memory, etc.), nonvolatile (read-only memory, flash memory etc.) or any combination thereof). These memory devices may be accessed by any of the hardware processors (e.g., the CPU) described herein to access computer readable program code of the wireless interference determination system 170.

As shown, the information handling system 100 may further include a video display device 142. The video display device 142, in an embodiment, may function as a liquid crystal display (LCD), an organic light emitting diode (OLED), a flat panel display, or a solid-state display. Although FIG. 1 shows a single video display device 142, the present specification contemplates that multiple video display devices 142 may be used with the information handling system to facilitate an extended desktop scenario, for example. In an embodiment, the video display device 144 may be used to present to a user instruction generated by execution of code instructions of the wireless interference determination system 170 regarding how to remedy detected wireless interference with the wireless dongle 160 as described herein. Additionally, the information handling system 100 may include one or more input/output devices 142 including an alpha numeric input device such as a keyboard 146 and/or a cursor control device, such as a mouse 152, touchpad/trackpad 150, a stylus 148, or a gesture or touch screen input device associated with the video display device 144 that allow a user to interact with the images, windows, and applications presented to the user.

A network interface device of the information handling system 100 shown as wireless interface adapter 128 can provide connectivity among devices such as with BT (e.g., 2.4 GHz band or other band with plural channels) or to a network 136, e.g., a wide area network (WAN), a local area network (LAN), wireless local area network (WLAN), a wireless personal area network (WPAN), a wireless wide area network (WWAN), or other network. In an embodiment, the WAN, WWAN, LAN, and WLAN may each include an access point 138 or base station 140 used to operatively couple the information handling system 100 to a network 136. In a specific embodiment, the network 136 may include macro-cellular connections via one or more base stations 140 or a wireless access point 138 (e.g., Wi-Fi or WiGig), or such as through licensed or unlicensed WWAN small cell base stations 140. Connectivity may be via wired or wireless connection. For example, wireless network access points 138 or base stations 140 may be operatively connected to the information handling system 100. Wireless interface adapter 128 may include one or more radio frequency (RF) subsystems (e.g., radio 130) with transmitter/receiver circuitry, modern circuitry, one or more antenna radio frequency (RF) front end circuits 132, one or more wireless controller circuits, amplifiers, antennas 134 and other circuitry of the radio 130 such as one or more antenna ports used for wireless communications via multiple radio access technologies (RATs). The radio 130 may communicate with one or more wireless technology protocols.

In an embodiment, the wireless interface adapter 128 may operate in accordance with any wireless data communication standards. To communicate with a wireless local area network, standards including IEEE 802.11 WLAN standards (e.g., IEEE 802.11ax-2021 (Wi-Fi 6E, 6 GHz)), IEEE 802.15 WPAN standards, WWAN such as 3GPP or 3GPP2, BT standards, or similar wireless standards may be used. Wireless interface adapter 128 may connect to any combination of macro-cellular wireless connections including 2G, 2.5G, 3G, 4G, 5G or the like from one or more service providers. In some embodiments, the wireless dongle 160 may be internal to the information handling system and may be a part of the wireless interface adapter 128 with an antenna 162 and a wireless hardware processing device such as a wireless controller 164, and may execute code instructions of the wireless dongle wireless interference detection system firmware 166. Utilization of radio frequency communication bands according to several example embodiments of the present disclosure may include bands used with BT wireless protocols by the wireless dongle 160. The wireless interface adapter 128 may also use wireless bands in the BT protocols as well as the WLAN standards and WWAN carriers which may operate in both licensed and unlicensed spectrums. The wireless interface adapter 128 can represent an add-in card, wireless network interface module that is integrated with a main board of the information handling system 100 or integrated with another wireless network interface capability, or any combination thereof. In an embodiment the wireless interface adapter 128 may include one or more radio frequency subsystems including transmitters and wireless controllers for connecting via a multitude of wireless links. In an embodiment, the execution of the wireless determination system 170 by the hardware processor 102 as well as the wireless dongle wireless interference detection system firmware 166 and the wireless interference detection algorithm 168 by the wireless dongle hardware processing device 164 may be conducted on behalf of the wireless interface adapter 128 used to communicate with a wireless device similar to the wireless dongle 160 communicating with the wireless device. In an example embodiment, an information handling system 100 wireless interface adapter 128 may have an antenna system transmitter for BT, Bluetooth® Low Energy (BLE), 5G small cell WWAN, or Wi-Fi WLAN connectivity and one or more additional antenna system transmitters for macro-cellular communication. The RF subsystems and radios 130 and include wireless controllers to manage authentication, connectivity, communications, power levels for transmission, buffering, error correction, baseband processing, and other functions of the wireless interface adapter 128.

As described herein, the information handling system 100 includes a wireless dongle 160 in some embodiments used to wirelessly couple the information handling system 100 to a wireless device. As described herein, the wireless dongle 160 includes a wireless dongle antenna 162 used to operatively couple with a wireless device and transmit and receive data to and from the wireless device. The wireless device, in an embodiment, may be a wireless video display device 144, a wireless keyboard 146, a wireless stylus 148, a wireless trackpad 150, a wireless mouse 152, or any other wireless peripheral device to which the wireless dongle 160 may be wirelessly coupled to. In an embodiment, the wireless dongle antenna 162 may be operated by a dedicated radio (not shown) or other antenna controlling device that allows the wireless dongle antenna 162 to transceive data at a band of frequencies such as those associated with the 2.4 GHz or other communication bands such as with the BT and BLE wireless protocols in some embodiments. The wireless dongle 160 may include a wireless dongle hardware processing device 164, such as a controller or other hardware processing resource, that also executes firmware that conducts this frequency scanning used by wireless devices to hop from one frequency to another based on RSSI values, frequency congestion, and other wireless considerations. The wireless dongle hardware processing device 164 also executes code instructions of the wireless dongle wireless interference detection system to detect interference in a communication band and on particular channels and determine RSSI levels of that interference signal. The wireless dongle hardware processing device 164 may be, in an example embodiment, a microcontroller integrated circuit with RF 2.4 GHz radio capabilities as well as able to execute firmware code instructions of embodiments herein. In other embodiments, the wireless dongle hardware processing device 164 may be a dedicated microcontroller device or other hardware processing resource.

In an embodiment, the wireless dongle hardware processing device 164 of the wireless dongle 160 may further execute wireless dongle wireless interference detection system firmware 166 including a wireless interference detection algorithm 168 used to detect fail parameters associated with the transmission and reception of data to and from the wireless device. The execution of the wireless dongle wireless interference detection system firmware 166 and the wireless interference detection algorithm 168 causes the wireless dongle 160 to observe wireless error patterns such as wireless frequency interference and levels of the same on one or more channels in the operating band of the wireless dongle 160, or weak signal issues. This initial process causes the wireless dongle hardware processing device 164 of the wireless dongle 160 to detect fail parameters such as an received signal strength indicator (RSSI) of interference at the wireless dongle antenna 162 that is above a first threshold interference RSSI value, determination of how many sampled channels at which this RSSI interference level is detected, a received data packet RSSI value for a data packet wireless communication signal that is over or under a second threshold data packet RSSI value, and/or a number of resend data packets exceeding a threshold level or value of resend data packets within a period of time.

For example, where the interference RSSI value at the wireless dongle antenna 162 is above a first threshold interference RSSI value, the wireless dongle hardware processing device 164 may, via execution of the wireless interference detection algorithm 168, determine whether that detected interference is among almost the entire spectrum of the 2.4 GHz ISM bands or other band by sampling plural channels or determine if the interference is particularized to a single channel. As described herein, the wireless dongle antenna 162 may be used to transmit across one of many frequency channels on the 2.4 GHz ISM band or other communication band such as that used with BT or BLE. Where interference is wideband and detected on plural sampled channels, execution of code instructions for the wireless interference determination system 170 by the hardware processor 102 may cause the generation of an instruction to a USB driver software to disable, limit, or alternate operations of one or more nearby USB ports 174 having a wireless dongle 160 or USB device 176. In another aspect, the wireless interference detection system 170 executed by the hardware processor 102 may generate instructions to generate a GUI notification to be presented via a display device 144 that the wireless dongle 160 location must be moved away from the USB device 176 or vice-versa. Where interference is detected on a single channel where the wireless device is operating on a specific frequency channel, execution of code instructions for the wireless interference determination system 170 by the hardware processor 102 may cause the wireless dongle antenna 162 to remedy transceiving on those particular frequencies by determining to generate instructions to switch channels within the BT/BLE band at the radio of the wireless dongle 160 or to generate a GUI notification to move the information handing system 100 or wireless dongle 160 location away from an interfering competing wireless device. Where, during execution of the wireless interference detection algorithm 168 by the wireless dongle hardware processing device 164, the wireless dongle hardware processing device 164 detects a weak data packet signal strength, the hardware processing device 102 executing the wireless interference determination system 170 to generate an instruction to increase the signal strength from the wireless IO device, such as IO devices 142 operatively coupled to wireless dongle 160 to overcome any interference or poor data signal performance.

Where the wireless dongle hardware processing device 164 detects an RSSI value of interference above a first threshold interference RSSI value that is found on a plurality of channels within a 2.4 GHz frequency band or other operating band, the wireless dongle hardware processing device 164 detects a first fail parameter, having two aspects including an RSSI level of interference signal detected and plural channels experiencing this interference, in an example embodiment. Where the interference RSSI value is above a certain value for at least one channel, then a plurality of channels may be sampled in some embodiments. Then, the wireless dongle hardware processing device 164 may move on to determine if other aspect of the fail parameter exists in just one channel or plural sampled channels. For example, the wireless dongle 160 may conduct frequency sampling across plural sample channels to detect or scan a plurality of chosen channels within the 2.4 GHz communication band for BT. Where the wireless dongle hardware processing device 164 detects an interference RSSI value above a first threshold interference RSSI value that is found on a single channel within a 2.4 GHz frequency band or other operating band, the wireless dongle hardware processing device 164 detects a second fail parameter, having two aspects including an RSSI level of interference signal detected and a single channel experiencing this interference, in an example embodiment. Where the detect interference RSSI value is not above the first threshold interference RSSI value, no interference is detected. Additionally, the wireless dongle hardware processing device 164 may determine other fail parameters such as low packet data signal RSSI levels and packet retry counts to determine the level of interference or other wireless problem occurring at the wireless dongle 160.

In an example embodiment, the fail parameters may include the detection of a received data packet RSSI value that is below a second threshold packet signal RSSI value. The RSSI value of the received packet is the RSSI value of the wireless data signal at the time a packet was received at the wireless dongle 160. Here, the wireless dongle hardware processing device 164 may detect whether the RSSI value of the wireless data signal related to a received packet provides information is at a strength such that a specific packet was successfully received. Where this signal strength associated with the receipt of a data packet is below the second threshold packet signal RSSI value, the wireless dongle hardware processing device 164 may determine that another fail parameter exists. Where this or another fail parameter exists, the wireless dongle hardware processing device 164 may move on to determine if yet another fail parameter exist such as determining if a number of packet retries is occurring indicating degradation of wireless data performance.

In an embodiment, a fail parameter may include a detection, by the wireless dongle hardware processing device 164 executing the wireless interference detection algorithm 168, of a threshold resend data packet that exceeds a threshold value. This is done by the wireless dongle hardware processing device 164 observing the number of data packets that are lost as a result of weak signals at a particular frequency or interference. Where the number of data packets that are lost and require retransmission exceeds a threshold number, the wireless dongle hardware processing device 164 determines that another fail parameter exists.

Depending on the fail parameters determined, the hardware processor 102 or other hardware processing resource may execute code instructions of the wireless interference determination system 170 along with the execution of the wireless dongle wireless interference detection system firmware 166 on the wireless dongle 160 to classify the interference type, such as wideband versus channel specific, or determine another problem such as a low packet data signal due to low power or distance. As a second process, the wireless dongle hardware processing device 164 may send the telemetry data for type of interference detected or levels of packet data signal strength obtained via execution of the wireless dongle wireless interference detection system firmware 166 with wireless interference detection algorithm 168 and the code instructions of the wireless interference determination system 170 to the hardware processor 102 of the information handling system 100. Because the wireless dongle 160 is operatively coupled to the information handling system 100 via a USB port 174, for example, the wireless dongle 160 may transmit this data to the hardware processor 102 of the information handling system 100.

With the type of interference or other wireless problem determined, the execution of code instructions of the wireless interference determination system 170 may generate an instructions for a remedial action such as generating notification to be presented via GUI on a display device 144 to a user or a determination of a change needed for software or hardware components such as USB port limitations, radio channel selection, or the power levels of transmission at a wireless dongle 160 or wireless IO device. During this second process, the hardware processor 102 may execute a wireless interference determination system 170 to troubleshoot the type of interference between wide band or channel specific interference, a weak signal strength, and lost data packets, to generate an instruction to be executed to remediate the problem including generating a notice displayed via GUI to require the user to adjust hardware for a remedial action. Based on which of the fail parameters that have been detected by the wireless dongle hardware processing device 164 and provided to the hardware processor 102, the hardware processor 102 may determine which instructions to generate for remedial action to software or hardware components to alleviate the interference at the wireless dongle 160 or improve data packet wireless signal performance.

A determination may include a determination that a neighboring USB 3.0 device to the wireless dongle 160 is causing interference issues that are wideband, a determination that one or more nearby wireless devices are causing interference that is channel-specific, or a determination of a weak signal due to transmit power levels or distance of a wireless device. A remedial action may include, for example, generating a GUI notification to the user of the information handling system 100 via a GUI that interference has been detected from a neighboring USB device (e.g., a USB 3.0 device such as a thumb drive) and that the user must change the location of either the wireless dongle 160 or the USB 3.0 device 176 to prevent or reduce this interference. Where interference is wideband and detected on plural sampled channels, execution of code instructions for the wireless interference determination system 170 by the hardware processor 102 may cause the generation of an instruction to a USB driver software to disable, limit, or alternate operations of one or more nearby USB ports 174 having a wireless dongle 160 or USB device 176 in other embodiments. Another remedial action may include generating an instruction to generate a GUI notification to the user of the information handling system 100 via a display device 144 that interference has been detected from a nearby wireless device and instructing the user to move the information handling system 100 or wireless dongle away from the competing wireless device. Where interference is detected on a single sampled channels, execution of code instructions for the wireless interference determination system 170 by the hardware processor 102 may cause the generation of an instruction to the wireless dongle 160 and its radio and to an operatively coupled wireless device to communicate using a different channel within the 2.4 GHz ISM band. Yet another remedial action may include generating an instruction to the wireless device via the wireless dongle indicating that the wireless device is to strengthen its wireless signal by, for example, increasing the transmission power or amplifying the signal at the frequency channel of communication or generating an instruction that the wireless device may be too far from the wireless dongle 160.

By executing the wireless dongle wireless interference detection system firmware 166 and wireless interference detection algorithm 168 at the wireless dongle hardware processing device 164 and the wireless interference determination system 170 at the hardware processor 102 of the information handling system 100, the systems and methods described herein may reduce negative feedback or data failure or retry rates experienced with wireless connection issues by wireless devices used with a wireless dongle 160. The troubleshooting methods described herein also may be used to telemetry feedback to a remote information handling system management system that is provided to a backend server 172 to determine how users are operating the information handling system with the wireless dongle as well as update, if necessary, the wireless interference detection algorithm to better detect and remediate wireless interference at the users' information handling systems. In an embodiment, the backend server 172 may include an information handling system management system such as Dell® SupportAssist®.

Thus, the present method and systems may more precisely identify radio frequency (RF) interference patterns, identify potential sources of this interference, and provide remedial actions that may be taken to correct these issues. The systems and methods described herein may also, via execution of the wireless dongle wireless interference detection system firmware 166 and wireless interference detection algorithm 168 by the wireless dongle hardware processing device 164 with the wireless interference determination system 170 at the information handling system 100, detect the source of poor wireless performance and provide that data to the host information handling system 100 for further processing and remedial action suggestions and processes.

In an embodiment, the information handling system 100 can include one or more sets of machine-readable code instructions, parameters, and profiles 112 that can be executed to cause the computer system to perform any one or more of the methods or computer-based functions disclosed herein. For example, machine-readable code instructions, parameters, and profiles 112 may execute, via hardware processing resources, various software applications, software agents, the BIOS 114 firmware and/or software, the wireless interference determination system 170, or other aspects or components. Machine-readable code instructions, parameters, and profiles 112 may execute, via the information handling system 100, the wireless interference determination system 170 that is used to identify the wireless interference issues experienced at the wireless dongle 160 and generate instructions via a graphical user interface (GUI) on display device 144 with suggestions for remedial actions as described herein that are determined by execution of code instructions of the wireless interference determination system 170 to be appropriate for the detected type of interference or wireless signal problem. Again, the machine-readable code instructions, parameters, and profiles 112 described herein may be software or firmware stored on a non-volatile memory device and made accessible to the embedded controller (EC) 104, the hardware processor 102, a microcontroller unit (MCU), or other hardware processing resource for execution. Various software modules comprising application instructions of machine-readable code instructions, parameters, and profiles 112 may be coordinated by an operating system (OS) 116, and/or via an application programming interface (API). An example OS 116 may include Windows®, Android®, and other OS types known in the art. Example APIs may include Win 32, Core Java API, or Android APIs.

In an embodiment, the disk drive unit 120 and may include machine-readable code instructions, parameters, and profiles 112 in which one or more sets of machine-readable code instructions, parameters, and profiles 112 such as software can be embedded to be executed by the processor 102 or other hardware processing devices such as a GPU 154 to perform the processes described herein. Similarly, main memory 106 and static memory 108 may also contain a computer-readable medium for storage of one or more sets of machine-readable code instructions, parameters, or profiles 112 described herein. The disk drive unit 120 or static memory 108 also contain space for data storage. Further, the machine-readable code instructions, parameters, and profiles 112 may embody one or more of the methods as described herein. In a particular embodiment, the machine-readable code instructions, parameters, and profiles 112 may reside completely, or at least partially, within the main memory 106, the static memory 108, and/or within the disk drive 120 during execution by the hardware processor 102, EC 104, or GPU 154 of information handling system 100. The main memory 106, GPU 154, EC 104, and the hardware processor 102 also may include computer-readable media.

Main memory 106 or other memory of the embodiments described herein may contain computer-readable medium (not shown), such as RAM in an example embodiment. An example of main memory 106 includes random access memory (RAM) such as static RAM (SRAM), dynamic RAM (DRAM), non-volatile RAM (NV-RAM), or the like, read only memory (ROM), another type of memory, or a combination thereof. Static memory 108 may contain computer-readable medium (not shown), such as NOR or NAND flash memory in some example embodiments. The applications and associated APIs, for example, may be stored in static memory 108 or on the disk drive unit 120 that may include access to a machine-readable code instructions, parameters, and profiles 112 such as a magnetic disk or flash memory in an example embodiment. While the computer-readable medium is shown to be a single medium, the term “computer-readable medium” includes a single medium or multiple media, such as a centralized or distributed database, and/or associated caches and servers that store one or more sets of machine-readable code instructions. The term “computer-readable medium” shall also include any medium that is capable of storing, encoding, or carrying a set of machine-readable code instructions for execution by a processor or that cause a computer system to perform any one or more of the methods or operations disclosed herein.

In an embodiment, the information handling system 100 may further include a power management unit (PMU) 122 (a.k.a. a power supply unit (PSU)). The PMU 122 may include a hardware controller and executable machine-readable code instructions to manage the power provided to the components of the information handling system 100 such as the hardware processor 102, and other hardware components described herein. The PMU 122 may control power to one or more components including the one or more drive units 120, the hardware processor 102 (e.g., CPU), the EC 104, the GPU 154, a video/graphic display device 144, or other wired input/output devices 142 such as the stylus 148, a mouse 152, a keyboard 146, and a trackpad 150 and other components that may require power when a power button has been actuated by a user. In an embodiment, the PMU 122 may monitor power levels and be electrically coupled, either wired or wirelessly, to the information handling system 100 to provide this power and coupled to bus 118 to provide or receive data or machine-readable code instructions. The PMU 122 may regulate power from a power source such as a battery 124 or AC power adapter 126. In an embodiment, the battery 124 may be charged via the AC power adapter 126 and provide power to the components of the information handling system 100, via wired connections as applicable, or when AC power from the AC power adapter 126 is removed. PMU 122 may include a hardware controller to operate with the EC 104 separately or together to execute machine-readable code instructions, parameters, and profiles 112 of the wireless interference determination system 170 at the information handling system 100.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or machine-readable code instructions may be stored.

In other embodiments, dedicated hardware implementations such as application specific integrated circuits (ASICs), programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses hardware resources executing software or firmware, as well as hardware implementations.

When referred to as a “system,” a “device,” a “module,” a “controller,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, controller, or module can include hardware processing resources executing software, including firmware embedded at a device, such as an Intel® brand processor, NODE® brand processors, Qualcomm® brand processors, or other processors and chipsets, or other such hardware device capable of operating a relevant software environment of the information handling system. The system, device, controller, or module can also include a combination of the foregoing examples of hardware or hardware executing software or firmware. Note that an information handling system can include an integrated circuit or a board-level product having portions thereof that can also be any combination of hardware and hardware executing software. Devices, modules, hardware resources, or hardware controllers that are in communication with one another need not be in continuous communication with each other, unless expressly specified otherwise. In addition, devices, modules, hardware resources, and hardware controllers that are in communication with one another can communicate directly or indirectly through one or more intermediaries.

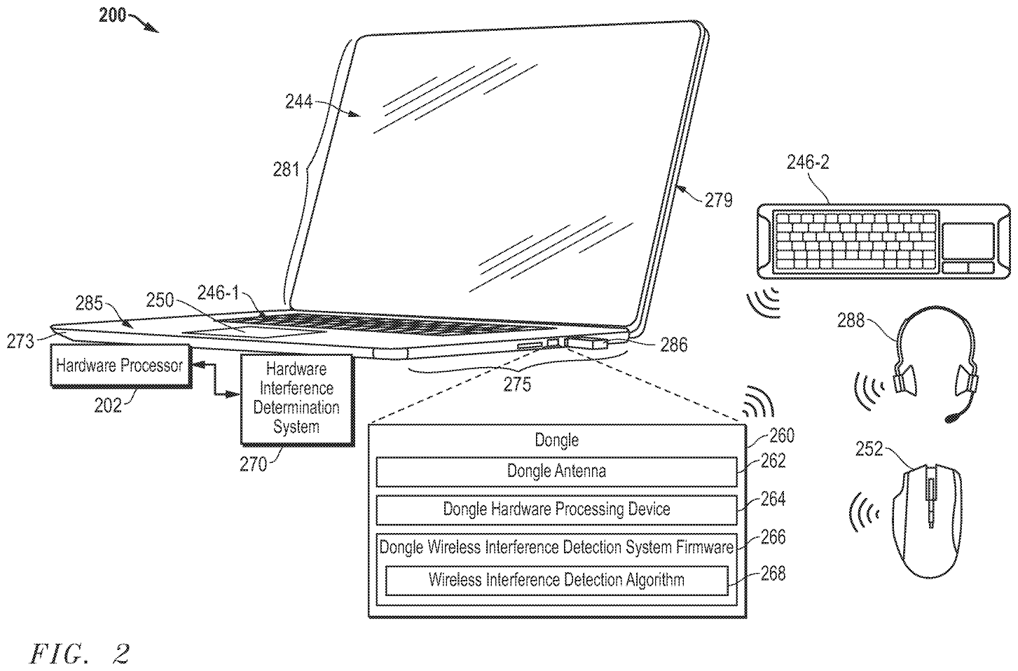

FIG. 2 is a graphic diagram of an information handling system 200 including a wireless dongle 260 used to operatively couple a wireless device to the information handling system 200 according to an embodiment of the present disclosure. As described herein, the information handling system 200 may include a USB device 286 that is operatively coupled to the information handling system 200 (e.g., operatively coupled to a bus of the information handling system) via a USB port (e.g., USB 3.0 port). This USB device 286 may be inserted into a USB port that is next to or otherwise proximate to the USB port where the wireless dongle 260 has been inserted into and is operatively coupled to the information handling system 200. As described herein, this may cause RF interference in some embodiments that the systems and methods described herein may detect, distinguish from other interference, and resolve.

The information handling system 200 shown in FIG. 2 is a laptop-type information handling system. However, as described herein, the information handling system 200 may include other types of information handling system 200 as described in connection with FIG. 1. The laptop-type information handling system 200 may include a base chassis 275 operatively coupled to a display chassis 281 via, for example, a hinge that allows the display chassis 281 to be closed onto the base chassis 275 and opened away from that base chassis 275. The display chassis 281 may include a bezel or a video display device 244 that is operatively coupled to the back display chassis 279 to form the display chassis 281. The base chassis 275 may include a bottom chassis 273 that is operatively coupled to a keyboard chassis 285 to form the base chassis 275. In an embodiment, the base chassis 275 may include a built-in keyboard 246-1 and trackpad 250 formed into the keyboard chassis 285 for the user to provide input to the information handling system 200.

As shown, the housing of the information handling system 200 may include one or more ports that allow one or more USB devices such as the USB device 286 and wireless dongle 260 to be inserted into these ports and be operatively coupled to a bus (not shown) and a hardware processor 202 formed within the housing of the information handling system 200. However, the present specification contemplates that an internal wireless interface adapter (with a radio and RF front end) may be affected by those devices and environments that cause interference as well and, as such, may also execute the wireless dongle wireless interference detection system firmware 266 similar to that of the wireless dongle 260 as described herein in some embodiments.

In an embodiment, the information handling system 200 includes a wireless dongle 260. The wireless dongle 260 may be operatively coupled, in an embodiment, with the information handling system 200 via a universal serial bus (USB) port formed in the housing of the information handling system 200 and operatively coupled to a hardware processor of the information handling system 200 via a bus (not shown) in an embodiment. In another embodiment, the wireless dongle 260 may be operatively coupled to the hardware processor of the information handling system 200 via a docking station (not shown) and connecting cable with the docking station also including a USB port for the wireless dongle 260 to be inserted into. In an embodiment, the wireless dongle 260 includes a wireless dongle antenna 262 used to provide wireless data communication with these devices and to scan channels for interference.

As described herein, the wireless dongle 260 includes a wireless dongle antenna 262 used to operatively couple with a wireless device and transmit and receive data to and from the wireless device. In an embodiment, the wireless dongle antenna 262 may be operated by a dedicated radio (not shown) or other antenna controlling device that allows the wireless dongle antenna 262 to transceive data at a band of frequencies such as those associated with the 2.4 GHz communication bands or other BT wireless frequency bands. The wireless dongle 260 may include a wireless dongle hardware processing device 264 that also executes firmware that conducts this frequency scanning used by wireless devices to scan from one frequency channel to another channel in a wireless band to determine interference RSSI values, channel interference, and other wireless issues. The wireless dongle hardware processing device 264 may be, in an example embodiment, a microcontroller integrated circuit with RF 2.4 GHz band radio capabilities or other BT radio capabilities.

In an embodiment, the wireless dongle hardware processing device 264 of the wireless dongle 260 may further execute wireless dongle wireless interference detection system firmware 266 including a wireless interference detection algorithm 268 used to detect fail parameters associated with detection of interference and the transmission and reception of data to and from the wireless device. The execution of the wireless dongle wireless interference detection system firmware 266 and the wireless interference detection algorithm 268 causes the wireless dongle 260 to observe wireless error patterns such as wireless frequency interference or weak signal issues. This initial process causes the wireless dongle hardware processing device 264 of the wireless dongle 260 to detect fail parameters such as received signal strength indicator (RSSI) levels of interference on at least one channel at the wireless dongle antenna 262 that is above a first threshold interference RSSI value, a number of channels sampled having this interference, a received data packets signal RSSI value that is over or below a second threshold data packet RSSI value, and/or a number of resend data packets exceeding a threshold resend data packet value within a period of time.

In an embodiment, a first fail parameter may include the detection that RSSI levels of interference on at least one channel at the wireless dongle antenna 262 is above a first threshold interference RSSI value. This RSSI level of interference may be detected on a single channel among a plurality of channels in the wireless band or may be detected on a plurality of channels among a plurality of channels in the wireless band. Where the RSSI level of interference is detected for a single or a plurality of channels among the plurality of channels in the wireless band, the wireless dongle hardware processing device 264 may determine that a fail parameter exists.

In another embodiment, a second fail parameter may include the detection of a received data packet RSSI value that is below a second threshold RSSI value. Here, the wireless dongle hardware processing device 264 may detect whether the RSSI value related to a received packet provides information about the strength of a specific packet or packets that were successfully received. Where this signal strength associated with the receipt of a data packet is below the second threshold RSSI value, the wireless dongle hardware processing device 264 may determine that a fail parameter exists. In an alternative, where this signal strength associated with the receipt of a data packet is above the second threshold RSSI value, the wireless dongle hardware processing device 264 this may be a fail parameter that reinforces another fail parameter such as an interference fail parameter.

In another embodiment, an additional fail parameter may include a detection, by the wireless dongle hardware processing device 264 executing the wireless interference detection algorithm 268, of a threshold number of resent data packet that exceeds a threshold value over a monitored period of time. This is done by the wireless dongle hardware processing device 264 observing the number of data packets that are lost as a result of interference or weak signals at a particular frequency channel or channels. Where the number of data packets that are lost and require retransmission exceeds a threshold number or rate over a monitored period of time, the wireless dongle hardware processing device 264 determines that another fail parameter exists.

These fail parameters may, when detected, inform the hardware processor 202 of the information handling system 200 which type of interference or other wireless issue is affecting the performance of the wireless dongle 260. For example, where the interference at the wireless dongle antenna 262 is detected to be above a first threshold interference RSSI value, the wireless dongle hardware processing device 264 may, via execution of the wireless interference detection algorithm 268, further detect whether interference at such a level is present among a plurality of sampled channels across the frequency band. Where an interference level meeting the first threshold interference RSSI value is detected on a plurality of channels, where a received data packets signal RSSI value is detected to be above a second threshold data packet RSSI value, and a number of resend data packets has exceeded a threshold resend data packet value within a period of time, this may indicate that a wide band interference is occurring nearby such as from a nearby USB port and is causing interference on the communication channel as well as other channels. Where, during execution of the wireless interference detection algorithm 268 by the wireless dongle hardware processing device 264, the wireless dongle hardware processing device 264 detects these set of fail parameters, an instruction to physically move the USB dongle 260 or another USB device at a USB port (e.g., relocate or cease using the neighboring USB ports on the information handling system 200) may be generated for display on a display device or an instruction to disable or limit usage of one or either of the neighboring USB ports may be generated. The generation of these instructions is done so as to reduce or avoid the wide band interference detected. In an embodiment, the hardware processor 202 may execute computer-readable program code to direct these instructions to be generated and presented on a video display device 244 of the information handling system 200 with the generated instructions indicating to a user via display on a display device to move the dongle 260 or not use a neighboring USB port. As described herein, the wireless dongle antenna 262 may be used to transmit across one of many channels on the 2.4 GHz ISM bands.

Where an interference level meeting the first threshold interference RSSI value is detected on only a single channel and the wireless device is operating on that specific frequency channel, where a received data packets signal RSSI value is detected to be above a second threshold data packet RSSI value, and a number of resend data packets has exceeded a threshold resend data packet value within a period of time, this may indicate that another nearby wireless device, perhaps wirelessly linked to another information handling system, is causing interference on that channel. Where, during execution of the wireless interference detection algorithm 268 by the wireless dongle hardware processing device 264, the wireless dongle hardware processing device 264 detects these set of fail parameters, an instruction to physically move the information handling system 200 (e.g., relocate the information handling system 200 to a different room) may be generated for display on a display device or an instruction to select a different frequency channel may be generated. The generation of these instructions is done so as to reduce or avoid the interference detected. In an embodiment, the hardware processor 202 may execute computer-readable program code to direct these instructions to be generated and presented on a video display device 244 of the information handling system 200 with the generated instructions indicating to a user via display on a display device that the user must move the information handling system 200 to a different location or select a different frequency channel used to communicate between the wireless dongle 260 and the wireless device.

Where the wireless dongle hardware processing device 264 does not detect an RSSI value of interference above the first threshold interference RSSI value over a plurality of these 2.4 GHz channels, where a received data packets signal RSSI value is detected to be below a second threshold data packet RSSI value, and a number of resend data packets has exceeded a threshold resend data packet value within a period of time, this may indicate that a weak signal between the wireless dongle 260 and the wireless device (e.g., 246-2, 288, 252) is present. Where, during execution of the wireless interference detection algorithm 268 by the wireless dongle hardware processing device 264, the wireless dongle hardware processing device 264 detects these set of fail parameters, an instruction to the wireless dongle 260 or the wireless device to increase the transmission power or amplify the wireless signal at the frequency of communication may be generated. The generation of these instructions is done so as to prevent data packet loss via this weak signal detected. In an embodiment, the hardware processor 202 may execute computer-readable program code to direct these instructions to be generated and presented to the wireless dongle 260 and/or wireless device. In an embodiment, the hardware processor 202 may execute computer-readable program code to direct these instructions to be transmitted to the wireless dongle 260 and/or wireless device automatically.

In embodiments herein, the wireless dongle hardware processing device 264 may send the telemetry data obtained via execution of the wireless dongle wireless interference detection system firmware 266 and wireless interference detection algorithm 268 to the hardware processor 202 of the information handling system 200. Because the wireless dongle 260 is coupled to the information handling system 200 via a USB port (e.g., USB 3.0 port for example), the wireless dongle 260 may transmit this data to the hardware processor 202 of the information handling system 200.

During this process, the hardware processor 202 may execute a wireless interference determination system 270 to troubleshoot the interference, weak signal strength, and lost data packet levels. Based on which of the fail parameters are detected by the wireless dongle hardware processing device 264 and provided to the hardware processor 202, the hardware processor 202 may determine and generate one or more instructions for remedial action to either display a message directing the user to adjust the USB port setup or location of the information handling system 200 or executed adjustments to the wireless radios at the wireless dongle 260 or wireless devices 246-2, 288, 252. For example, a remedial action may include generating a notification message via a graphical user interface (GUI) at a video display device 244 to the user of the information handling system 200 that interference has been detected from a neighboring USB device (e.g., a USB 3.0 device such as a thumb drive) and that the user must change the location of either the wireless dongle 260 or the USB 3.0 device to prevent this interference. Still another remedial action may include the generation of an instruction, via the hardware processor 202, to limit use of one or both USB ports at a USB driver that the wireless dongle 260 or USB 3.0 device is coupled. Another remedial action includes generating a notification via a GUI message at the video display device 244 that interference from another wireless device is detected and the user must move the information handling system or other wireless device in order to alleviate this interference. Yet another remedial action may include generating an instruction, via the hardware processor 202, to the radio at the wireless dongle 260 and wireless device to communicate using a different channel on the 2.4 GHz ISM band. Another remedial action may include, for example, a transmission to the wireless device instructing the wireless device to strengthen its wireless signal by, for example, increasing the transmission power or amplifying the signal at the frequency of communication.

By executing the wireless dongle wireless interference detection system firmware 266 and wireless interference detection algorithm 268 at the wireless dongle hardware processing device 264 and the wireless interference determination system 270 at the hardware processor 202 of the information handling system 200, the systems and methods described herein may determine a type of interference experienced with wireless connection issues at a wireless dongle 260 from among a plurality of issues of interference or signal. The troubleshooting methods described herein also report interference signal telemetry, data packet signal telemetry, and data packet retry data to a backend server 272 operating an information handling system management service to determine how users are operating the information handling system with the wireless dongle as well as update, if necessary, the wireless interference detection algorithm to better detect and remediate wireless interference at the users' information handling systems. In an embodiment, the backend server 272 may execute code instructions of software operating on information management service such as Dell® SupportAssist®.

In an example embodiment, the hardware processor 202 may execute the wireless interference determination system 270 to conduct a number of steps. As a first step, the hardware processor 202 may determine whether the wireless dongle 260 detects an interference value at one or more of the channels within the 2.4 GHz bands that are above a threshold interference RSSI value of interference for a period of time. In one embodiment, the threshold interference RSSI value may be set to between −80 dBm and −90 dBm (decibel-milliwatts) and the period of time may be 1 second. In one example embodiment, the threshold interference RSSI value may be −88 dBm. In an embodiment, the number of channels within the 2.4 GHz band sampled across a low, a mid, and a high portions of the 2.4 GHz band may be five. Where the threshold interference RSSI value across these five channels within the 2.4 GHz ISM band over the period of time falls above this threshold RSSI value of interference, the hardware processor 202 may determine that a broadband interference from a neighboring USB port is occurring. Via execution of the wireless interference determination system 270, that broadband interference is being detected among plural channels among the 2.4 GHz ISM bands. This indicates that, for example, the operation of the USB device 286 at the USB port next to or otherwise proximate to the port where the wireless dongle 260 is located is creating electromagnetic radiation interference with the wireless signal functions of the wireless dongle 260 for packet data signals.

As another step, the hardware processor 202, executing the wireless interference determination system 270, may determine whether the wireless dongle 260 detects an interference RSSI value at a single channel within the 2.4 GHz bands that are above a threshold interference RSSI value of interference for a period of time. In one embodiment, the threshold interference RSSI value may be set to −88 dBm (decibel-milliwatts) and the period of time may be 1 second. In an embodiment, the channel within the 2.4 GHz band sampled includes the channel on which the wireless dongle 260 is transceiving data with the wireless device. Where the threshold interference RSSI value at this channel over the period of time falls above this threshold RSSI value of interference, the hardware processor 202 may determine that a signal interference from other nearby wireless devices using the same channel to communicate (e.g., another information handling system communicating with a separate wireless device that is not associated with the information handling system 200 operating the wireless dongle).

As another step, the hardware processor 202, executing the wireless interference determination system 270, may determine whether the received data packets signal RSSI value is below a second threshold data packet RSSI value. In an embodiment, the second threshold RSSI data packet value may be −70 dBm. Where this second threshold RSSI data packet value is below the −70 dBm, for example, for any given packet transmission signal, this may indicate that the wireless device is too far away to transceive data packets to and from the wireless dongle 260 or that the transmission power is too low in an embodiment. If the data packet signal is above the second data packet threshold RSSI value for normal signal transmission, this may reinforce that any lost data packets may be due to interferences sources determined above.

As still another step, the hardware processor 202, executing the wireless interference determination system 270, may determine how may data packets, if any, needed to be resent over a given time period of monitoring (e.g., 100 ms). Where a threshold number of data packets were determined to have been resent, this may indicate that the data packet communication wireless signal is experiencing enough interference or that the data packet signal from the wireless device is too weak such that it is degrading or halting operation of the wireless dongle 260 or wireless device 246-2, 288, 252. In one example embodiment, the threshold number of packets that are resent is 70 over a detection time period such as 100 ms. Such a fail parameter my need to be realized first before the wireless interference determination system 270 generates an instruction for a remedial action since otherwise data packet communications are being conducted successfully despite interference and intervention is unnecessary in some embodiments.

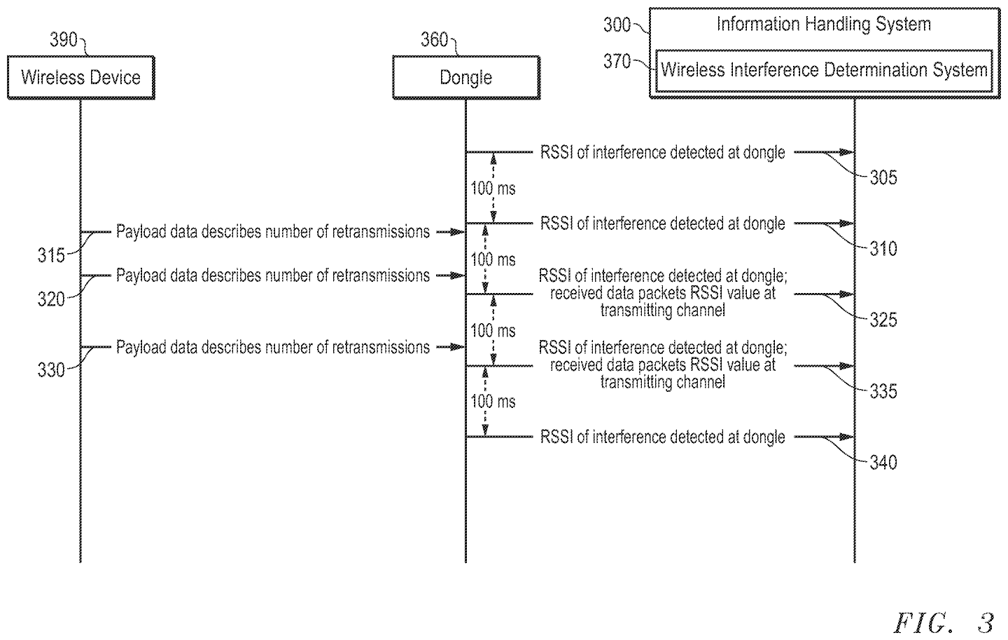

FIG. 3 is a process flow diagram showing a process of gathering and transmitting interference data and packet signal data to and from a wireless dongle 360 operatively coupled to an information handling system 300 via a universal serial bus (USB) port according to an embodiment of the present disclosure. As described herein, the wireless device 390 may provide data packets on a data packet wireless signal to the wireless dongle 360. The wireless dongle 360 may detect and provide interference RSSI levels, data packet communication signal RSSI levels as well as other data to the information handling system 300 including the number of sampled channels in a wireless frequency band experiencing such interference levels.

At line 305, for example, the wireless dongle 360 may transmit interference RSSI data for interference levels detected at one or more sampled channels to the information handling system 300. As described herein, this interference RSSI data may be descriptive of the interference levels detected by the wireless dongle 360. Again, this interference RSSI data may be used by the wireless dongle 360 to determine whether the first threshold interference RSSI value has been reached or not and whether the current RSSI values of interference have risen above this first threshold interference RSSI value over a period of time across, for example, five sample channels within the 2.4 GHz ISM bands. At 310, this process for detection of interference levels may be repeated any number of times and may be repeated within a set period of time (e.g., 100 ms). Still further, the dongle 360 may determine, at lines 325 and 335, the received data packet RSSI signal value at a transmitting channel upon receiving data packets on wireless communication signals at lines 315, 320, and 330. This data indicates whether the second data packet RSSI value threshold has been reached or not when data packets are received from the wireless device 390 at a specific channel within the 2.4 GHz band. In other words, a determination is made of the strength of the data packet signal and whether it meets a threshold data packet RSSI signal value. Additionally, ongoing detection of interference levels is conducted and these are transmitted to the information handling system as well at 325 and 335. As indicated by lines 310, 325, 335, and 340, this process may be conducted at specific intervals of time. In an example embodiment, this interval of time is 100 ms but the present specification contemplates that at least this interference RSSI data sent to the wireless dongle 360 may be relayed to the information handling system 300 at more frequent intervals or less frequent intervals.

As indicated by lines 315, 320, and 330, the wireless device 390 may transmit payload packet data on a wireless communication signal. The payload packet data may include data that describes the number of retransmissions that were required to pass the necessary data (e.g., keystroke data, mouse positional data, etc.) to the wireless dongle 360. It is appreciated that the data packets may be retransmitted with headers indicating that the transmission of any given data packet was a subsequent retransmission of that data packet due to a previously failed transmission. It is further appreciated that because the wireless device 390 and the dongle 360 are communicating with each other, the number of retransmission packets that were required to be sent to the dongle may be described in a specific transmission from the wireless device 390 to the dongle 360. As described herein, this packet retransmission data may be used by the wireless dongle 360, executing the wireless interference detection algorithm at the wireless dongle hardware processing device, to determine whether a threshold number of retransmissions of packets (e.g., 70 times) from the wireless dongle 360 has been exceeded over a specific period of time (e.g., 100 ms). This data may be presented to the wireless dongle 360 as the wireless dongle 360 receives input data from the wireless device 390 and may not be transmitted on a regular basis. As such, the wireless dongle 360 may not know when this payload data is going to be received and may include this payload data with the interference RSSI data and any data packet signal RSSI data transmitted from the wireless dongle 360 to the information handling system 300 when it is received. The information handling system 300 executing code instructions of the wireless interference determination system 370 may determine among the fail parameters indicating types of interference occurring or levels of packet data signal strength of receiving data packet signals to generate instructions for remediation instructions for generating messages at a GUI or causing radio system or USB operational adjustments according to embodiments herein.

Further, as indicated at lines 325 and 335, regular transmission of the interference RSSI data, the data packet communication signal RSSI data, and packet retry data from the wireless dongle 360 to the information handling system 300 may occur. The payload data may be included with the above data when it is available from the wireless dongle 360 in the information handling system 300 for use with the execution of code instructions of the wireless interference determination system 370. In an example, FIG. 3 shows at lines 315 and 320 that payload data is received within the 100 ms time period between when the wireless dongle 360 transmits the interference RSSI data, the data packet communication signal RSSI data, and packet retry data. As can be seen, therefore, at line 325, both sets of payload data received between lines 310 and 325 (e.g., the 100 ms time period) at lines 315 and 320 is accumulated and sent off to the information handling system 300 by the wireless dongle 360 for further processing to determine if signal interferences have been detected, the type of interference, and which, if any, remedial action instructions are to be generated as described in embodiments herein.

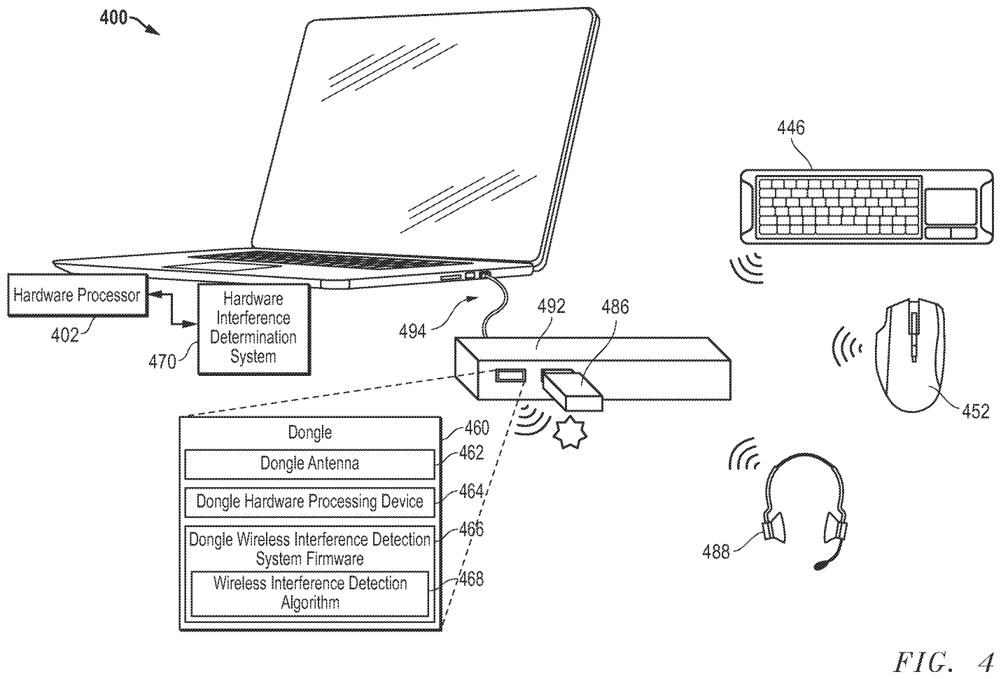

FIG. 4 is a block diagram of an arrangement of a wireless dongle 460 and information handling system 400 relative to a plurality of wireless devices wirelessly coupled to the information handling system 400 via a docking station 492 that includes the wireless dongle 460 according to another embodiment of the present disclosure. As shown, the housing of the information handling system 400 may include one or more USB ports that allows a docking station 492 to be operatively coupled to the information handling system 400 and the hardware processor 402 therein. The docking station 492 may include one or more USB devices such as the USB device 486 and wireless dongle 460 that may be inserted into those ports formed into the housing of the docking station 492. Because the docking station 492 is operatively coupled to a bus and the hardware processor 402 of the information handling system, the wireless dongle 460 and USB device 486 is also operatively coupled to a bus (not shown) and the hardware processor 402 formed within the housing of the information handling system 400. As described herein, the wireless dongle 460 is connected to a USB port (e.g., USB 3.0) that, in the context of the present specification, wirelessly communicates with a wireless device such as a wireless mouse 452, a wireless keyboard 446, a wireless headset 488, among other peripheral wireless devices, and base stations and access points among other wireless devices. As such, in an embodiment, the wireless dongle 460 includes a wireless dongle antenna 462 used to provide wireless communication with these devices.

As described herein, the wireless dongle 460 includes a wireless dongle antenna 462 used to operatively couple with a wireless device and transmit and receive data to and from the wireless device. In an embodiment, the wireless dongle antenna 462 may be operated by a dedicated radio (not shown) or other antenna controlling device that allows the wireless dongle antenna 462 to transceive data at one or more channels such as those associated with and within the 2.4 GHz communication bands or other wireless band such as those supported by the BT and BLE protocols. The wireless dongle 460 may include a wireless dongle hardware processing device 464 that also executes firmware that conducts this frequency channel scanning used by wireless devices to hop from one frequency to another based on RSSI values, frequency congestion, and other wireless considerations and to detect interference RSSI levels on one or more sampled channels according to embodiments herein via the dongle antenna 462. The wireless dongle hardware processing device 464 may be, in an example embodiment, a microcontroller integrated circuit with RF 2.4 GHz or other wireless band radio capabilities.

In an embodiment, the wireless dongle hardware processing device 464 of the wireless dongle 460 may further execute wireless dongle wireless interference detection system firmware 466 including a wireless interference detection algorithm 468 used to detect fail parameters associated with detected interference and with the transmission and reception of packet data to and from the wireless device. The execution of the wireless dongle wireless interference detection system firmware 466 and the wireless interference detection algorithm 468 causes the wireless dongle 460 to observe wireless error patterns such as wireless frequency interference or weak signal issues. This initial process causes the wireless dongle hardware processing device 464 of the wireless dongle 460 to detect fail parameters such as an RSSI value of interference at the wireless dongle antenna 462 that is above a first threshold interference RSSI value, a received data packet RSSI signal value that is over or below a second threshold data packet RSSI value, and/or a number of resend data packets exceeding a threshold resend data packet value within a period of time. For example, where the interference RSSI value at the wireless dongle antenna 462 is above a first threshold interference RSSI value of interference, the wireless dongle hardware processing device 464 may, via execution of the wireless interference detection algorithm 468 determine whether that interference is on a single channel or wide band across plural sampled channels. If this interference is detected across a selected number of sampled channels, it is determined that the spectrum of the 2.4 GHz ISM bands is experiencing wideband interference. As described herein, the wireless dongle antenna 462 may be used to transmit across one of many channels on the 2.4 GHz ISM bands. Where some interference or low signal strength is detected where the wireless device is operating on a specific frequency, the radio of the wireless dongle 460 may cause the wireless dongle antenna 462 to adjust its operation to transceive on those particular frequencies with higher power, recommend switching channels, or generate a message to move the information handling system. Where, during execution of the wireless interference detection algorithm 468 by the wireless dongle hardware processing device 464, the wireless dongle hardware processing device 464 detects interference or weak signal strength on only a single channel, the wireless interference determination system 470 may instruct that a different frequency may be selected to reduce the interference. Where transmission value measured is weak instruction may be generated to increase the signal strength. Where the wireless dongle hardware processing device 464 detects an interference RSSI value above a first threshold interference RSSI value over a plurality of these 2.4 GHz frequency channels, then the wireless dongle hardware processing device 464 detects one of a plurality of fail parameters that indicates a wideband interference and generates instructions for corresponding remedies such as generating a message for display to move either the wireless dongle or the nearby USB device away from one another or generating an instruction to limit or alternate use of USB ports in example embodiments herein.

In other embodiments, the fail parameters may include the detection of a received data packet RSSI value that is above a second threshold RSSI value which may reinforce that any packet loss is due to interference when the data packet signals are sufficiently strong. Here, the wireless dongle hardware processing device 464 may detect whether the data packet signal RSSI value related to a received packet was successfully received and its signal strength. Where this signal strength associated with the receipt of a data packet is below a second threshold data packet RSSI value, the wireless dongle hardware processing device 464 may determine that a different fail parameter exists indicating weak signal strength as well.

In an embodiment, yet another fail parameter may be required before instructions are generated to implement remedial measures which includes a detection, by the wireless dongle hardware processing device 464 executing the wireless interference detection algorithm 468, of a threshold number of resent data packets that exceeds a threshold value during a monitoring period. This is done by the wireless dongle hardware processing device 464 observing the number of data packets that are lost as a result of interference or weak signals and require a resend. Where the number of data packets that are lost and require retransmission exceeds a threshold number during a monitoring period, the wireless dongle hardware processing device 464 determines that this fail parameter exists. This fail parameter may be required in some embodiments before remedial instructions are generated since if data packets are not being lost despite interference or transmission power levels, there may not be a need to conduct remediation in some embodiments.

The wireless dongle hardware processing device 464 may send the data obtained via execution of the wireless dongle wireless interference detection system firmware 466 and wireless interference detection algorithm 468 to the hardware processor 402 of the information handling system 400 executing the wireless interference determination system 470. Because the wireless dongle 460 is coupled to the information handling system 400 via a USB port (e.g., USB 3.0 port for example) at the docking station 492 operatively coupled to the information handling system 400 via a docking port cable 494, the wireless dongle 460 may transmit this data to the hardware processor 402 of the information handling system 400.

During this second process, the hardware processor 402 may execute code instructions of a wireless interference determination system 470 to troubleshoot the fail parameters to determine type of interference, weak signal strength, or lost data packets. Based on which of the fail parameters that are detected by the wireless dongle hardware processing device 464 and provided to the hardware processor 402, the hardware processor 402 may determine which remedial action to generate instructions. Execution of the code instructions of the wireless interference determination system 470 generates a GUI message or a modification of operation of the radio system as any of several remedial actions.

A remedial action may include notifying the user of the information handling system 400 that interference has been detected from a neighboring USB device (e.g., a USB 3.0 device such as a thumb drive) and that the use can change the location of either the wireless dongle 460 or the USB 3.0 device must be changed to prevent this interference. Another remedial action may include executing computer code to generate instructions to alternate the activity between neighboring USB ports via instructions presented to a USB controller (e.g., USB hardware processor). These instructions may cause the alternating activation of a USB port where the dongle is present and a neighboring USB port where a USB 3.0 wireless device is operating. This prevents signal interference between these two devices in an embodiment. Another remedial action may include limiting operation of one of the USB ports until a location change is made for either the wireless dongle or the USB device. Another remedial action may include generating a notification via a GUI message at the video display device 444 that interference from another wireless device is detected and the user must move the information handling system or other wireless device in order to alleviate this interference. Yet another remedial action may include causing the wireless dongle 460 and wireless device to communicate using a different channel on the 2.4 GHz ISM band. Still another remedial action may include, for example, a transmission to the wireless device indicating that the wireless device is to strengthen its wireless signal by, for example, increasing the transmission power or amplifying the signal at the frequency of communication.

By executing the wireless dongle wireless interference detection system firmware 466 and wireless interference detection algorithm 468 at the wireless dongle hardware processing device 464 and the wireless interference determination system 470 at the hardware processor 402 of the information handling system 400, the systems and methods described herein may reduce negative feedback or annual failure rates experienced with wireless connection issues using the wireless dongle 460, wireless I/O devices (e.g., wireless devices 446, 452, or 488) or with the docking station 492. The troubleshooting data on interference or signal levels and instructions for remediation described herein also may be provided as telemetry data to a backend server 472 to determine how users are operating the information handling system with the wireless dongle as well as update, if necessary, the wireless interference detection algorithm to better detect and remediate wireless interference at the users' information handling systems. In an embodiment, the backend server 472 may include an information handling system 400 management service software such as Dell® SupportAssist®.

In an example embodiment, the hardware processor 402 may execute the wireless interference determination system 470 to conduct a number of processes. As a first process, the hardware processor 402 may determine if the data from the wireless dongle 460 indicates an interference RSSI value of interference at one or more channels within the 2.4 GHz bands that are above a first interference RSSI threshold value for a period of time (e.g., seconds or milliseconds). In one embodiment, the threshold interference RSSI value may be set to between −80 dBm and −90 dBm (decibel-milliwatts) and the period of time may be 1 second. In one example embodiment, the threshold interference RSSI value may be −88 dBm. In an embodiment, the number of channels within the 2.4 GHz bands sampled by the wireless dongle 460 may be five. Where the threshold RSSI value of interference across these five channels within the 2.4 GHz ISM bands over the period of time falls above this threshold RSSI value (e.g., −88 dBm or higher), the hardware processor 402 may determine, via execution of the wireless interference determination system 470, that wide band interference is being detected across the 2.4 GHz ISM band. It is understood that other threshold levels, time periods, and sampled channels number may be used in other embodiments. This may indicate that the operation of the USB device 486 at the USB port next to the port where the wireless dongle 460 is located is creating electromagnetic radiation interference with the transceiving of packet data signals at the wireless dongle 460 in an embodiment.

As another step, the hardware processor 402, executing the wireless interference determination system 470, may determine whether the wireless dongle 460 detects an interference RSSI value at a single channel within the 2.4 GHz bands that are above a threshold interference RSSI value of interference for a period of time. In one embodiment, the threshold interference RSSI value may be set to −88 dBm (decibel-milliwatts) and the period of time may be 1 second. In an embodiment, the channel within the 2.4 GHz band sampled includes the channel the wireless dongle 460 is transceiving with the wireless device. Where the threshold interference RSSI value at this channel over the period of time is above this threshold RSSI value of interference, the hardware processor 402 may determine that a signal interference from other nearby wireless devices using the same channel to communicate (e.g., another information handling system communicating with a separate wireless device).

As another step, the hardware processor 402, executing the wireless interference determination system 470, may determine whether the received data packet RSSI signal value that is below a second threshold data packet RSSI value. In an embodiment, the second threshold data packet RSSI value may be −70 dBm. Where this second threshold data packet RSSI value is below the −70 dBm (e.g., −70 or lower), this may indicate that the wireless device is too far away or the signal is too weak to transceive data packets to and from the wireless dongle 460. Again, it is appreciated that other threshold levels, time periods, or sampled channels may be used in other embodiments.

As another step, the hardware processor 402, executing the wireless interference determination system 470, may determine how may data packets, if any, needed to be resent. Where a threshold number of data packets were determined to have been resent during a monitoring period, this may indicate that the signal from the wireless device is failing due to one or more fail parameters as identified and remediation instructions must be generated. In some embodiments, the fail parameter of a determination of more than a threshold of packet retries is a failsafe parameter before any remediation instructions are generated since a need for remediation may not be necessary in some embodiments unless packet retries are occurring. In an example embodiment, where the threshold number of packets that are resent is 70 over a detection time period such as 100 ms, this may trigger this particular fail parameter indicating a remediation instruction is required from the wireless interference determination system 470. Again, any number of resent packets may be a threshold and any time period may be used in various embodiments.

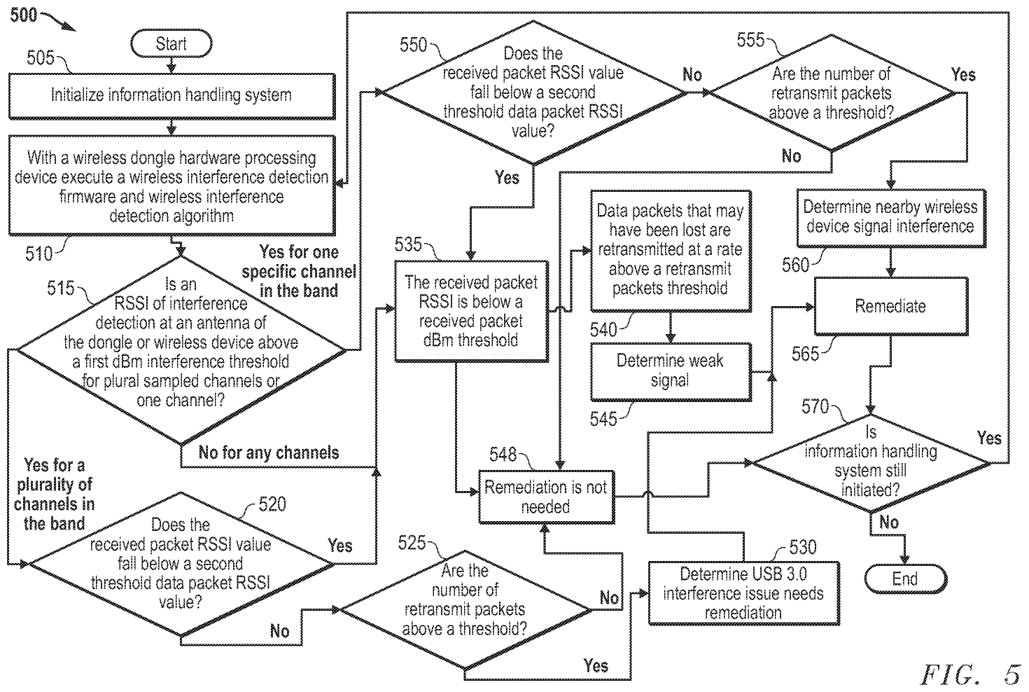

FIG. 5 is a flowchart diagram of a method 500 of detecting and troubleshooting wireless interference at a wireless dongle operatively coupled to an information handling system via a universal serial bus (USB) port according to an embodiment of the present disclosure. The method 500 may include initializing the information handling system at block 505. In an embodiment, this may be done by the user actuating a power button on the information handling system. As the information handling system is initialized, the PMU may provide power to the USB ports into which the wireless dongle is inserted. Additionally, the bus may operatively couple the wireless dongle to CPU or other hardware processing device to allow for data transmission from the wireless dongle to the hardware processing device.

At block 510, the method 500 includes executing a wireless dongle wireless interference detection system firmware including the wireless interference detection algorithm with a wireless dongle hardware processing device. The execution of the wireless dongle wireless interference detection system firmware and wireless interference detection algorithm allows the wireless dongle to receive the packet data and gather the interference RSSI data via its wireless dongle antenna across channels in a wireless communications band in embodiments herein. The wireless dongle wireless interference detection firmware also detects, when executed by the wireless dongle hardware processor, data packet signal RSSI values associated with the transmissions between the wireless dongle and the wireless device as described herein. Again, the interference RSSI data describes the RSSI values of interference, where present, at the wireless dongle from interference sources. The received data packet RSSI value describes data packet wireless signal strength for transceiving data packets between the wireless dongle and the wireless device. Additionally, data packet resend statistics may be gathered from the wireless I/O devices in payload. This data may be accumulated per FIG. 3 and sent on to a hardware processor of the information handling system.

At block 515, the execution of the wireless interference detection algorithm by the hardware processor of the wireless dongle determines whether an interference RSSI value at the wireless dongle antenna is above the first threshold interference RSSI value. For example, where the interference RSSI value at the wireless dongle antenna is above a first threshold interference RSSI value, the wireless dongle hardware processing device may detect and determine whether interference is detected among one or more sampled channels of the spectrum within the 2.4 GHz ISM bands at block 515. In an embodiment, the threshold interference RSSI value may be −88 dBm and the period of time may be 1 second although other values may be used in various embodiments. In one embodiment, the number of channels within the 2.4 GHz band may be five although other values may be used in various embodiments. It is appreciated, and the present specification contemplates, that the first threshold interference RSSI, the number of sampled channels monitored, and the period of time may be changed to accommodate for a particular level of detection and the examples presented herein are provide merely as examples.

Where the first threshold interference RSSI value of interference is detected over a plurality of sampled channels within the 2.4 GHz ISM bands over the period of time at or above this threshold interference RSSI value at block 515, this may indicate a fail parameter of wide band interference between the wireless dongle and a nearby USB 3.0 device is present. In this example embodiment, the method 500 may continue to block 520 in order to determine whether a received data packet signal strength is above a receive packet dBm RSSI threshold, thus, reinforcing that any experienced data packet loss is due to interference rather than weak signal. Again, at block 520, the wireless dongle hardware processor may determine the data packet RSSI value of the data packet wireless signal at the time of receipt of any given number of packets over a period of time from the wireless device. In an embodiment, this period of time is 100 ms, however the present specification contemplates that any period of time may be selected to accommodate for transceiving requirements between the wireless dongle and the wireless device.

Where the hardware processor, after receiving this received data packet RSSI values at block 520, determines that the receive packet RSSI value is above a second threshold data packet RSSI value and, for a plurality of channels within the 2.4 GHz bands, the interference RSSI of rises above the first threshold interference RSSI value, this may continue to indicate interference with a neighboring USB 3.0 device.

At block 525, the execution of the wireless interference determination system may determine if the number of retransmit packets are above a threshold number of retransmit packets. Where, at block 525 the number of retransmit packets exceeds the retransmit packet threshold, the execution of a wireless interference determination system via a hardware processor of the information handling system may determine that the cause of these lost packets are interference due to the presence of a USB 3.0 device being present and operating too close to the wireless dongle at block 530. In such an embodiment, the USB 3.0 device may be generating wide band interference rather than the data packet signal being too weak. As such, the hardware processor of the information handling system may, at block 565 generate instructions to remediate the issue. In an example embodiment, this remediation instruction may include generating and presenting at a GUI on a video display device of the information handling system a message to the user that the interference from the USB 3.0 device has been detected and that the wireless dongle must be moved away from the USB 3.0 device or the USB 3.0 device should be relocated to another USB port (e.g., a USB port in a connected docking station). Additionally, or alternatively, the instructions generated may instruct the USB driver associated with the operation of the wireless dongle and the USB 3.0 device to limit or alternate one or both of the USB ports into which the wireless dongle and USB 3.0 device are operatively coupled to the information handling system. Where retransmitted packets during a monitoring period has not reached a threshold number of data packets at block 525, then the flow proceeds to block 548 and it is determined that no remediation is needed. Flow may then proceed to block 570 to determine if the information handling system is still initiated and operating.

It is appreciated as well that the wireless dongle hardware processor may detect the RSSI value of interference at a plurality of channels within the 2.4 GHz band at block 515 but the received packet RSSI wireless signal level is detected as low and below a second data packet RSSI threshold at block 520. In this example embodiment, the method 500 continues to block 535 with the hardware processor of the information handling system determining that the received packet channel wireless signal is below a received packet dBm threshold and, at block 540, this may have caused the data packets to have been lost and need to be retransmitted at a rate above a retransmit packets threshold. Where this occurs, however, the hardware processor of the information handling system, at block 545, may determine that a weak signal is present and generate instructions to conduct a remedial action at block 565. In an example embodiment, this remedial action may include the hardware processor of the information handling system to generate and send a command or instructions to the wireless device or wireless dongle to increase the signal strength of transmissions between them.

It is appreciated that, in some example embodiments, the wireless dongle hardware processor may determine that the RSSI value of interference is detected above the first threshold interference RSSI value for a single channel in the 2.4 GHz band at block 515. When this occurs, the method 500 proceeds to block 550 with the wireless dongle hardware processor determining whether the received data packet RSSI value is above a received data packet dBm threshold similar to that described in connection with block 520. This may reinforce that any lost data packets are due to the interference and not due to a weak signal. Where is it determined, at block 550, that the received data packet RSSI value exceeds the second data packet RSSI value threshold, the method 500 continues to block 555 with determining whether a number of retransmit packets value is above a retransmit packet threshold. Where, at block 555, the hardware processor of the information handling system has received the data that the retransmit packet number during a monitoring period is above a retransmit packet number threshold, the hardware processor may determine, via execution of the wireless interference determination system (e.g., FIG. 1, 170) that nearby wireless devices are creating interfering wireless signals on that channel at block 560. Where retransmitted packets during a monitoring period has not reached a threshold number of data packets, then the flow proceeds to block 548 and it is determined that no remediation is needed. Where, however, the resent number of data packets does exceed the threshold, for example, a wireless device operation with a separate information handling system nearby may be using a similar or the same channel is the BT or BLE wireless band causing lost data packets. Again, the method 500 may include, at block 565, with the hardware processor of the information handling system generating instructions for a remedial action. In an embodiment, instructions for remedial action may include generating and presenting to a user via a video display device of the information handling system a GUI message directing the user to move the information handling system or the other wireless device (e.g., the wireless device creating interference with the communication of the wireless dongle) to a less wirelessly congested area. In an embodiment, the instructions for remedial action may include generating an instruction to switch from the current channel in the band to another channel where the wireless dongle radio can communicate and transceive with the wireless device.

It is appreciated that the wireless dongle hardware processor may have detected an interference RSSI value at a single channel among the 2.4 GHz ISM bands at block 515 but that the received data packet RSSI value does exceed a second RSSI value at 550. This indicates that the data packet signal is low and below a dBm data packet RSSI threshold at block 535. Proceeding to block 540, when the number of retransmits of packets does exceed a retransmit packet threshold value then this indicates weak data packet wireless signal strength at block 545. At this point within the method 500, the hardware processor of the information handling system may determine, at block 545, that the weak data packet wireless signal is present and the hardware processor of the information handling system generates an instruction as a remedial action at block 565. In an example embodiment, this instruction generated for the remedial action may include the hardware processor of the information handling system to send a command or instruction to the wireless device via the wireless dongle to increase the signal strength of transmissions to the wireless dongle and may increase power at the wireless dongle as well.

It is also appreciated that the wireless dongle hardware processor may have detected a RSSI value of interference at a single channel among the 2.4 GHz ISM bands at block 515. At block 550 the wireless dongle hardware processor may have determined that the received packet RSSI value does exceed a second threshold data packet RSSI value at block 550. If, at block 555, the number of retransmit data packets does not exceed a retransmit number threshold during a period however, then the flow proceeds to block 548. At block 548, generating a remediation instruction is not needed since the data packets are successfully being transmitted despite interference in an embodiment. The method 500 then continues to block 570 to continue monitoring if the information handling system is still initiated and operating. Where, at block 570, the information handling system is no longer initiated, the method 500 ends.

It is further appreciated that, at block 515, where the wireless dongle hardware processor determines that the interference RSSI is not present at any of the channels to meet an interference RSSI threshold within the 2.4 GHz ISM band, the method 500 continues to block 535 with the hardware processor of the information handling system determining that the received packet channel is below a received packet dBm threshold. At block 540, when this causes the data packets to be lost and retransmitted at a rate above a retransmission number threshold, the hardware processor of the information handling system, at block 545, may determine that a weak signal is present via the execution of code instructions of the wireless interference detection system. Proceeding to block 565, execution of code instructions of the wireless interference detection system generates instructions to conduct a remedial action at block 565. In an example embodiment, the generated instructions for this remedial action may include the hardware processor of the information handling system to direct the wireless dongle to send a command or instruction to the wireless device to increase the signal strength of transmissions to the wireless dongle or for the wireless dongle to increase power.

After remedial actions have been conducted pursuant to the instructions generated by the hardware processor of the information handling system at block 565, the method 500 may also include, at block 570, determining whether the information handling system is still initiated or not. Where the information handling system is no longer initiated at block 570, the method 500 may end. Where the information handling system is still initiated at block 570, the method may return to block 510 with the wireless dongle continuing to execute the wireless interference detection algorithm and executing those processes and determinations at blocks 515, 520, and 525 to monitor for interference or other degradation in wireless dongle wireless performance.

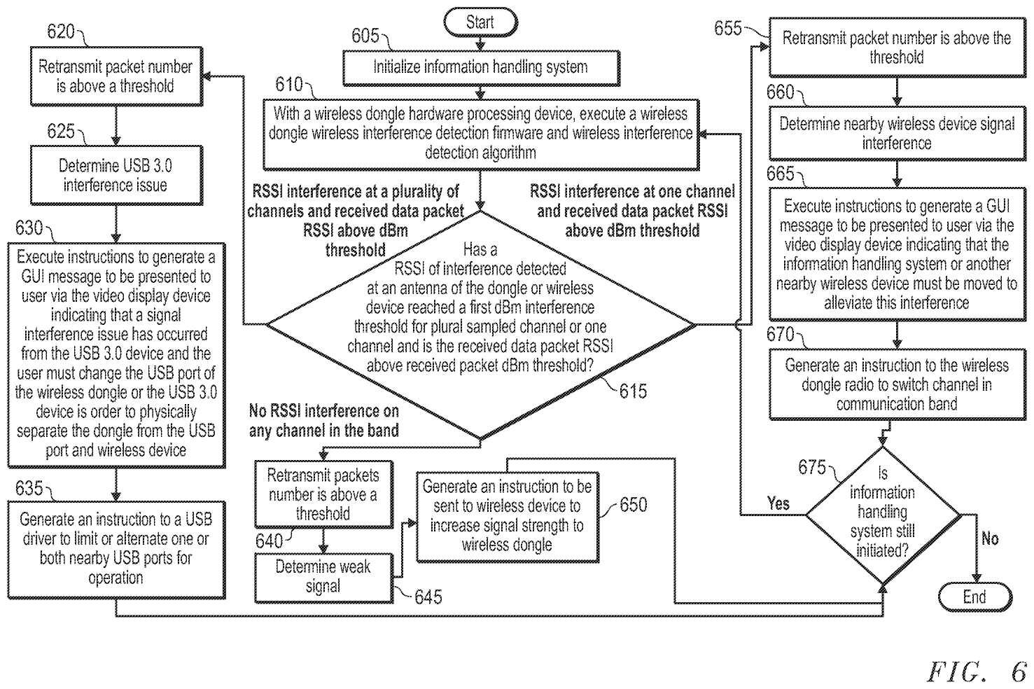

FIG. 6 is a flowchart diagram of a method 600 of generating commands or instructions for executing remedial actions upon a determination that wireless interference has been detected or data packet signal levels are low at a wireless dongle according to an embodiment of the present disclosure. As described herein, generating commands or instructions for the remedial actions are conducted by the hardware processing device of the information handling system executing of code instructions of the wireless interference detection system and may depend on the data provided by the wireless dongle hardware processor as described in connection with FIG. 5. For example, the wireless dongle hardware processor may determine fail parameters indicating interference, type of interference, low signal, packet retries, or other fail parameters described herein.

The method 600 may include initializing the information handling system at block 605. In an embodiment, this may be done by the user actuating a power button on the information handling system. As the information handling system is initialized, the PMU may provide power to the USB ports into which the wireless dongle is inserted. Additionally, the bus may operatively couple the wireless dongle to CPU or other hardware processing device to allow for data transmission from the wireless dongle to the hardware processing device.

At block 610, the method 600 includes executing a wireless dongle wireless interference detection system firmware with a wireless dongle hardware processing device or a hardware processor of a wireless interface adapter (e.g., FIG. 1, 128). The execution of the wireless interference detection firmware allows the wireless dongle to gather the interference RSSI data associated with a plurality of sampled channels between the wireless dongle and the wireless device via its wireless dongle radio antenna system as described herein. The execution of the wireless interference detection firmware also allows the wireless dongle to gather the received data packet signal strength data as described herein. Again, this interference RSSI data describes the RSSI values of interference, where present, between the wireless dongle and the information handling system. The received data packet RSSI value describes RSSI values of the data packet communication wireless signal on which data packets are transceived between the wireless IO device and the wireless dongle or wireless adapter. Further, a wireless IO device may track and report to a wireless dongle or wireless adapter, data on packet retries over a monitoring period or periods. This data may be accumulated (e.g., per FIG. 3) and sent on to a hardware processor of the information handling system executing code instructions of a wireless interference determination system to determine interference or low signal issues and generate instructions for remedial adjustments according to embodiments herein.

The method 600 also includes, at block 615, execution of code instructions of the wireless interference detection system at the wireless dongle has detected and the execution of code instructions of the wireless interference determination system at the information handling system determines from that data whether the interference RSSI value detected at an antenna of the wireless dongle or wireless device reached a first dBm threshold interference RSSI for a plural sampled channel or one channel and whether the received data packet RSSI is above a received packet dBm threshold in an embodiment. As described in connection with FIG. 5, these series of fail parameters may be individually determined to be present and taken in various combinations are used by the execution of code instructions of the wireless interference determination system to determine which remedial action is to be taken, if any.

In an example, the method 600, execution of the wireless dongle wireless interference detection system firmware and wireless interference detection algorithm by the hardware processor of the wireless dongle may detect at block 615 that the interference RSSI value has reached a first dBm interference threshold at a plurality of channels in the wireless band. Further, the execution of code instructions of the wireless dongle wireless interference detection system may detect that the received data packet RSSI is above a received data packet dBm threshold. Then the execution of code instructions of the wireless interference determination system at the information handling system may determine that a wideband interference is occurring, such as from a neighboring USB port, and that the interference rather than weak packet data signal may be causing issues for transceiving data packets. In one example embodiment at block 620, the method 600 includes determining that the number of retransmit packets are above a threshold number of retransmit packets to confirm that a data packet retransmission at a high of a level is occurring and potentially degrading performance. In some embodiments the data packet retry fail parameter may not be required, in other embodiments it may be a failsafe determination required to be met before generation of any remediation instructions. As a consequence of this combination of fail parameters being present, the hardware processor execution of code instructions of the wireless interference determination system determines that a USB 3.0 device has interfered with the data packet transmissions between the wireless dongle and the wireless device as a result at block 625.

It is appreciated that where the execution of the wireless dongle wireless interference detection system firmware indicates that the number of retransmitted packets has not reached the threshold number of retransmit packets at block 620 if such a fail parameter is required as a failsafe in some embodiments, the hardware processor may determine no remediation instruction is needed and will not generate any message or instructions. In such a case, remediation is not necessary since although there was interference detected across a plurality of channels in the wireless band, the data being transmitted from the wireless device to the wireless dongle is being received. Therefore, the communication between these two devices is not interrupted sufficiently to affect their operation. Where no remediation is necessary in this example, the method 600 may continue to block 675, rather than execute steps 630 or 635, and eventually return to block 610 if the information handling system is still operating.

Where it is determined, via the execution of the wireless interference determination system (e.g., FIG. 1, 170) by the hardware processor of the information handling system, that the cause of the interference is the presence and operation of the USB 3.0 device at block 625 and retransmit packet numbers are above a threshold at 620 in one embodiment, the method 600 further includes the hardware processor generating instructions for a remedial action at block 630 or at block 635. In the case of the presence of the USB 3.0 device at block 630, the remedial action includes executing instructions to generate a GUI message that is to be presented to the user indicating that a signal interference issue has occurred from the USB 3.0 device and the user must change the USB port of the wireless dongle or the USB 3.0 device in order to physically separate the two devices. Because some USB 3.0 devices may be manufactured differently, the level of RF shielding may vary among USB 3.0 device manufactures. Where this shielding is insufficient to prevent RF interference with the wireless dongle and its wireless data communications, the execution of the wireless interference determination system by the hardware processor of the information handling system instructs a display device to display a message that directs that the user must change the physical location of the USB 3.0 device in a USB port next to the wireless dongle or change physical location of wireless dongle so that the operation of the two devices will not affect the wireless operations at the wireless dongle. By changing the location of the USB 3.0 device and/or wireless dongle to a different USB port (e.g., a USB port located in a docking station operatively coupled to the information handling system), the interference may be abated or eliminated.

Additionally, or alternatively, at block 635 the hardware processor may execute code instructions of the wireless interference determination system to generate computer readable instructions to limit or alternate operations at one or both of the neighboring USB ports into which the wireless dongle and USB 3.0 device are operatively coupled to the information handling system at block 635. These generated instructions may be generated by the hardware processor and sent, via the bus, to a USB driver for execution. By alternating the operation of these two devices, the electrical interference from the USB 3.0 device is not realized at the wireless dongle and the operation of both may continue unaffected. After providing these instructions to generate the GUI message (at bock 630) and/or generate instructions to the USB ports, the method 600 may continue to block 675 as described herein.

In an alternative scenario, at block 615 for example, the method 600 includes a determination by the hardware processor that no RSSI interference is detected on any channels within the wireless band (e.g., 2.4 GHz ISM band) and the received data packet RSSI is below a received data packet dBm threshold. As such, at block 640, the method 600 includes determining that the number of retransmit packets are above a threshold number of retransmit packets. Where this occurs, the hardware processor of the information handling system, executing the computer-readable program code of the wireless interference determination system, may determine that a weak signal is present at block 645. As a remedial action for this weak signal detection at block 645, the hardware processor of the information handling system executing code instructions of the wireless interference determination system may generate an instruction to be sent to the wireless dongle 260 or the wireless device to increase the transmission power or amplify the wireless signal at the frequency of communication. The generation of these instructions is done so as to prevent data packet loss via this weak signal detected. In an embodiment, the hardware processor 202 may execute computer-readable program code to direct these instructions to be generated and presented to the wireless dongle 260 and/or wireless device. In an embodiment, the hardware processor 202 may execute computer-readable program code to direct these instructions to be transmitted to the wireless dongle 260 and/or wireless device automatically. In an embodiment, the signal strength may be increased, for example, by the wireless device and/or wireless dongle amplifying the signal from a wireless antenna therein, by the wireless device and/or wireless dongle engaging in an antenna tuning process, or the wireless device and/or wireless dongle changing the orientation of their respective antennas. After providing these instructions to generate these instructions to the wireless device, wireless dongle, or both at bock 650, the method 600 may continue to block 675 as described herein.

In another example, the method 600 includes the determination that a nearby wireless device signal is interfering with the wireless data packet communications between the wireless dongle and the wireless device at block 615. In this example embodiment, execution of code instructions of the wireless dongle wireless interference detection system determine that the interference RSSI value has reached a first dBm interference threshold at a single channel in the wireless band and the received data packet signal strength is above a dBm threshold. With sufficiently strong data packet signal strength, this reinforces that the interference may be causing any degradation in wireless performance at the wireless dongle. Where this occurs, the method 600 further includes in some embodiments, at block 655, determining that the number of retransmit packets are above a threshold number of retransmit packets as a failsafe condition before generating remediation instructions. As a consequence of this combination of fail parameters being present, the hardware processor determines that a nearby wireless device signal is causing interference at block 660. For example, a wireless device operation with a separate information handling system nearby may be using a similar or the same channel in the BT or BLE wireless band. As a remedial action, at block 665, the hardware processor of the information handling system may generate and present to a user, via a video display device of the information handling system, a GUI message directing the user to move the information handling system or the other wireless device (e.g., the wireless device creating interference with the communication of the wireless dongle) further apart or to a less wirelessly congested area. In another embodiment, the instructions generated for remedial action may additionally or alternatively include, at block 670, generating an instruction to switch from the current channel in the band to another channel where the wireless dongle radio can communicate and transceive with the wireless device. In some embodiments, such as where it is determined that retransmit packet numbers have not exceeded a retry threshold, the flow may proceed directly to block 675 without generating instructions for any remedial action such as in blocks 665 or 670 and as described with respect to FIG. 5.

After any of these remedial actions has been executed by the hardware processor of the information handling system executing of code instructions of the wireless interference detection system or it is determined that no instructions for remedial action are needed, the method 600 may include, at block 675, with determining whether the information handling system is still initiated or not. Where the information handling system is no longer initiated at block 670, the method 600 may end. Where the information handling system is still initiated at block 670, the method may return to block 610 with the wireless dongle detecting and providing the interference data and data packet signal information to the hardware processor and continuing to execute the wireless interference determination system to diagnose and generate instructions for remedial actions, if any.

The blocks and steps of the flow diagrams of FIGS. 5 and 6 or steps and aspects of the operation of the embodiments herein and discussed above need not be performed in any given or specified order. It is contemplated that additional blocks, steps, or functions may be added, some blocks, steps or functions may not be performed, blocks, steps, or functions may occur contemporaneously, and blocks, steps, or functions from one flow diagram may be performed within another flow diagram.

Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents and shall not be restricted or limited by the foregoing detailed description.

What is claimed is:

1. An information handling system comprising:
a hardware processing device, a memory device and a power management unit (PMU) to provide power to the hardware processing device and the memory device;
a plurality of universal serial bus (USB) ports;
a wireless dongle operatively coupled to the hardware processing device via a first USB port of the information handling system and wirelessly coupled to a wireless device, the wireless dongle via a wireless radiofrequency (RF) band comprising:
a wireless dongle antenna to send and receive data wirelessly with the wireless device;
a wireless dongle hardware processing device executing code instructions of a wireless dongle wireless interference detection firmware comprising a wireless interference detection algorithm to detect fail parameters from an interference received signal strength indicator (RSSI) value detected at the wireless dongle antenna, a received data packet RSSI signal value, and a number of resend data packets; and
the hardware processing device, upon detection that the interference RSSI value is above a first threshold interference RSSI value at one or more channels in the wireless RF band, the received data packet RSSI signal value is detected above a second threshold data packet RSSI signal value, and the number of resend data packets exceeds a threshold resend data packet value, executes computer readable program code instructions of a wireless interference determination system to determine that a wideband interference is occurring at a plurality of sampled channels in the wireless RF band when the plurality of sampled channels are above the first threshold interference RSSI.

2. The information handling system of claim 1 further comprising:
the hardware processor executing computer readable program code of the wireless interference determination system to determine that the plurality of sampled channels across the wireless RF band having the interference RSSI value that exceeds the first threshold interference RSSI value indicates that wideband interference is being caused by a USB device operatively coupled to a second USB port neighboring the first USB port and generating instructions to conduct a remedial action to reduce the wideband interference.

3. The information handling system of claim 1 further comprising:
the hardware processor executing the computer readable program code of the wireless interference determination system to generate instructions to conduct a remedial action to generate a graphical user interface (GUI) message to be presented a user on a video display device of the information handling system instructing the user move the wireless dongle away from an interfering wireless source.

4. The information handling system of claim 1 further comprising:
the hardware processor executing the computer readable program code of the wireless interference determination system to generate instructions to a USB driver to disable, limit, or alternate operations of a second USB port having a USB device or a first USB port having the wireless dongle.

5. The information handling system of claim 1 further comprising:
the hardware processor executing computer readable program code of the wireless interference determination system determining that a single channel within the wireless band has the interference RSSI value that exceeds the first threshold interference RSSI value to determine that interference is being caused by interference of a wireless signal from a second wireless device.

6. The information handling system of claim 4 further comprising:
the hardware processor executing the computer readable program code of the wireless interference determination system to generate instructions to perform a remedial action to generate a GUI message to be presented to a user of the information handling system via a video display device instructing the user to move the information handling system away from the second wireless device.

7. The information handling system of claim 4 further comprising:
the hardware processor executing the computer readable program code of the wireless interference determination system to generate to the wireless dongle, wireless device, or both to switch from the single channel in the wireless band where interference is detected to another channel in the wireless RF band.

8. The information handling system of claim 1 further comprising:
the hardware processor, in executing computer readable program code of the wireless interference determination system, determines that the interference RSSI value is not above the first threshold interference RSSI value at one or more channels in the wireless RF band, that the received data packet RSSI value is not above the second threshold data packet RSSI value, and the number of resend data packets exceeds the threshold resend data packet value, the hardware processor determines that a weak signal is present between the wireless device and the wireless dongle; and
the hardware processor generates instructions to the wireless device, the wireless dongle, or both to increase wireless transmission power used to communicate data packets.

9. The information handling system of claim 1 further comprising:
a docking station operatively coupled to the information handling system, the docking station including the plurality USB ports and the wireless dongle being operatively coupled into the first USB port of the plurality of USB ports with another USB device being operatively coupled to a second USB port of the other plurality of USB ports.

10. The information handling system of claim 1, wherein the first threshold interference RSSI value is between −80 dBm and −90 dBm.

11. A wireless dongle operatively coupled to an information handling system at a universal serial bus (USB) port, comprising:
a wireless dongle antenna to send and receive data wirelessly with a wirelessly coupled wireless device via a wireless radiofrequency (RF) band;
a wireless dongle hardware processing device executing computer readable program code instructions of a wireless dongle wireless interference detection firmware system comprising a wireless interference detection algorithm to, when executed by the wireless dongle hardware processing device, detect fail parameters from an interference received signal strength indicator (RSSI) value at the wireless dongle antenna, a received data packet RSSI value, and a number of resend data packets detected;
the wireless dongle hardware processing device to send data to the information handling system to determine, via execution of computer readable program code instructions of a wireless interference determination system, that the interference RSSI is above a first threshold interference RSSI value at one or more channels in the wireless RF band, the received data packet RSSI value is above s second threshold data packet RSSI value, and the number of resend data packets exceeds a threshold resend data packet value indicates that one of a wideband interference or a specific channel interference is degrading wireless performance at a channel in the wireless RF band; and
the computer readable program code instructions of the wireless interference determination system generates instructions to remediate interference depending on whether the wideband interference or the specific channel interference is degrading wireless performance at the channel.

12. The wireless dongle claim 11, wherein a plurality of sampled channels across the wireless RF band have the interference RSSI value that exceeds the first threshold interference RSSI value indicates that the wideband interference is determined and is caused by a USB device operatively coupled to a neighboring USB port neighboring a USB port where the wireless dongle has been inserted.

13. The wireless dongle claim 11, wherein the computer readable program code of the wireless interference determination system generates instructions to conduct a remedial action to remediate interference including generating a graphical user interface (GUI) message to be presented to a user on a video display device of the information handling system instructing the user move the wireless dongle away from an interfering wireless source.

14. The wireless dongle claim 11, wherein the computer readable program code of the wireless interference determination system generates instructions to a USB driver to disable, limit, or alternate operations of neighboring USB ports on the information handling system when wideband interference is determined.

15. The wireless dongle of claim 11, wherein when a single channel within the wireless RF band has the interference RSSI value that exceeds the first threshold interference RSSI value, the wireless interference determination system determines that interference is being detected at this single channel is caused by interference of a wireless signal from a second wireless device not associated with the information handling system and wireless interference determination system to generates instructions to perform a remedial action including:
generating a GUI message to be presented to a user of the information handling system via a video display device instructing the user to move the information handling system from the second wireless device; or
generating instructions to the wireless dongle, wireless device, or both to switch from the single channel in the wireless band where interference is detected to another channel in the wireless RF band.

16. The wireless dongle of claim 11, wherein where the interference RSSI is not above the first threshold interference RSSI value at one or more channels in the wireless band, the received data packet RSSI value is not above the second threshold data packet RSSI value, and the number of resend data packets exceeds the threshold resend data packet value, the hardware processor of the information handling system determines that a weak signal is present between the wireless device and the wireless interference determination system generates instructions to perform a remedial action including automatically generating instructions to the wireless device, the wireless dongle, or both to increase wireless transmission power used to communicate data packets.

17. A method of detecting and troubleshooting wireless interference at a wireless dongle operatively coupled to an information handling system via a universal serial bus (USB) port comprising:
transceiving data packets between the wireless dongle and an operatively coupled wireless device for the information handling system in a wireless radio frequency (RF) band;
receiving from a wireless dongle hardware processing device, executing computer readable program code instructions of a wireless dongle wireless interference detection firmware system comprising a wireless interference detection algorithm to detect an interference received signal strength indicator (RSSI) value at the wireless dongle antenna, a received data packet RSSI value, and a number of resend data packets within a period of time;
determining with a hardware processor at an information handling executing computer readable program code of a wireless interference determination system a type of wireless interference at a wireless dongle antenna selected from a wideband interference from a second USB port neighboring a first USB port having the wireless dongle and a specific channel interference from a competing, nearby second wireless device based on a number of sampled channels having the interference RSSI value detected at the wireless dongle antenna; and
generating instructions, via the wireless interference determination system, to perform a remedial action to correct the wireless device signal interference identified based on the type of wireless interference determined.

18. The method of claim 17 further comprising:
the hardware processing device executing the computer readable program code of the wireless interference determination system to generate instructions to display a graphical user interface message to a user of the information handling system to move the wireless dongle away from an interfering wireless source selected from the second USB port neighboring a first USB port having the wireless dongle and the competing, nearby second wireless device depending on the type of wireless interference determined.

19. The method of claim 17 further comprising:
determining, via the hardware processing device executing the wireless interference determination system, that a plurality of sampled channels across low, medium, and high ranges of the wireless RF band have the interference RSSI value that exceeds the first threshold interference RSSI value indicates that the wideband interference is being caused by a USB device operatively coupled to the second USB port neighboring the first USB port; and
generating instructions to a USB driver to disable, limit, or alternate operations of the second USB port or the first USB port.

20. The method of claim 17, further comprising:
executing computer readable program code of the wireless interference determination system via the hardware processor to determine that the interference RSSI is not above the first threshold interference RSSI value at one or more channels in the wireless band, the received data packet RSSI value is not above the second threshold data packet RSSI value, and the number of resend data packets exceeds the threshold resend data packet value indicates that a weak signal is present between the wireless device and the wireless dongle degrading wireless performance of the wireless dongle; and
generating instructions to the wireless device, the wireless dongle, or both to increase wireless transmission power.
